(19) United States
(12) Patent Application Publication
(10) Pub. No.: US 2025/0125557 A1
(43) Pub. Date: Apr. 17, 2025

(54) Connector Assembly and Its Female-Side Connector and Male-Side Connector

(71) Applicant: Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 18/745,581

(22) Filed: Jun. 17, 2024

(30) Foreign Application Priority Data
Jun. 16, 2023 (TW) 112122775
Jun. 16, 2023 (TW) 112122776

(51) Int. Cl. H01R 13/627; H01R 13/506

(52) U.S. Cl. CPC H01R 13/627; H01R 13/506

(57) ABSTRACT

A female-side connector assembly and its female-side connector and male-side connector, wherein the provided female-side connector and male-side connector are equipped with a metal shell and an insulating base. The metal shell can mate with the insulating base to form a locking side wall, allowing the male-side connector to lock the female-side connector through the locking side wall, preventing the male-side connector from disengaging from the locked female-side connector. This addresses the technical issues of the male-side connector easily disengaging from the locked female-side connector, ensuring that the signal transmission functionality between the female-side connector and the male-side connector meets expectations, thereby enabling the connector assembly to be widely applied in various electronic devices.

### CROSS-REFERENCE TO RELATED APPLICATIONS

This application claims the priority of Republic of China Patent Application Nos. 112122775 and 112122776 filed on Jun. 16, 2023, in the State Intellectual Property Office of the R.O.C., the disclosure of which is incorporated herein by reference.

### BACKGROUND OF THE INVENTION

### Field of the Invention

The present application relates to the technical field of electronic devices, and more specifically, to a connector assembly and its female-side connector and male-side connector that can maintain the joining relationship of conductive terminals to ensure that the signal transmission function meets expectations.

### Descriptions of the Related Art

The male-side connector can join with the female-side connector to form the connector assembly, which comprises been widely used in recent years for signal transmission across various electronic devices.

However, with the trend of electronic devices becoming lighter, thinner, and more compact, internal space in electronic devices comprises been significantly reduced, forcing a reduction in the size of both male-side and female-side connectors. As a result, the male-side connector may become more prone to disengaging from the joined female-side connector, thus causing a loss in the intended signal transmission functionality of the male-side connector and female-side connector.

In view of the foregoing, addressing issues such as the tendency of the male-side connector to easily disengage from the joined female-side connector comprises become an urgent problem for professionals in the relevant technical field.

### SUMMARY OF THE INVENTION

In view of the drawbacks of the prior art mentioned above, the present application provides a female-side connector, which enables to join with a male-side connector, and the female-side connector comprises: a female-side conductive terminal, comprising a female-side terminal joining structure; a female-side insulating base, being embedded with the female-side conductive terminal; and a female-side metal shell, being connected with the female-side insulating base, enables the female-side metal shell to mate with the female-side insulating base to form a female-side mating body, and the female-side mating body comprises a female-side joining space and a female-side locking side wall, wherein the female-side terminal joining structure is located within the female-side joining space, and the female-side locking side wall comprises a first female-side locking direction and a second female-side locking direction, and the first female-side locking direction extends along a first female-side locking direction extension line, and the second female-side locking direction extends along a second female-side locking direction extension line, and the first female-side locking direction extension line and the second female-side locking direction extension line can extend and intersect substantially, and the female-side locking side wall also comprises a first female-side locking structure and a second female-side locking structure, wherein the female-side locking side wall guides the male-side connector into the female-side joining space to join with the female-side terminal joining structure; and when the male-side connector enters the female-side joining space, the first female-side locking structure locks the male-side connector in the first female-side locking direction, and the second female-side locking structure locks the male-side connector in the second female-side locking direction, to maintain the joining relationship between the female-side terminal joining structure and the male-side connector.

Preferably, the female-side connector said above, wherein the first female-side locking direction extension line and the second female-side locking direction extension line intersect substantially perpendicularly.

Preferably, the female-side connector said above, wherein the first female-side locking structure and the second female-side locking structure are positioned on the female-side metal shell.

Preferably, the female-side connector said above, wherein the first female-side locking structure is positioned on the female-side metal shell, and the second female-side locking structure is positioned on the female-side insulating base.

Preferably, the female-side connector said above, wherein the female-side locking side wall also comprises a third female-side locking direction, and the third female-side locking direction extends along a third female-side locking direction extension line, and the third female-side locking direction extension line and the second female-side locking direction extension line can extend and intersect substantially with each other, and the female-side locking side wall further comprises a third female-side locking structure, wherein when the male-side connector enters the female-side joining space, the third female-side locking structure locks the male-side connector in the third female-side locking direction to maintain the joining relationship between the female-side terminal joining structure and the male-side connector.

Preferably, the female-side connector said above, wherein the third female-side locking direction extension line and the second female-side locking direction extension line intersect substantially perpendicularly.

Preferably, the female-side connector said above, wherein the third female-side locking structure is positioned on the female-side metal shell or the female-side insulating base.

Preferably, the female-side connector said above, wherein he first female-side locking structure, the second female-side locking structure, and the third female-side locking structure are either recessed structures or protruding structures.

Preferably, the female-side connector said above, wherein the female-side metal shell comprises a first female-side metal locking sub-shell, a second female-side metal locking sub-shell, and a third female-side metal locking sub-shell, in the female-side mating body, the first female-side metal locking sub-shell, the second female-side metal locking sub-shell, and the third female-side metal locking sub-shell are bent and mated with the female-side insulating base, respectively, wherein the first female-side locking structure is positioned on the first female-side metal locking sub-shell, the second female-side locking structure is positioned on the second female-side metal locking sub-shell, and the third female-side locking structure female-side locking structure is positioned on the third female-side metal locking sub-shell.

Preferably, the female-side connector said above, wherein the second female-side metal locking sub-shell connects with the third female-side metal locking sub-shell, enabling the second female-side metal locking sub-shell and the third female-side metal locking sub-shell to form a bent structure that can mate with the female-side insulating base.

Additionally, the present application provides a male-side connector, which enables to join with a female-side connector, and the male-side connector comprises: a male-side conductive terminal, comprising a male-side terminal joining structure; a male-side insulating base, being embedded with the male-side conductive terminal; and a male-side metal shell, being connected with the male-side insulating base, enables the male-side metal shell to mate with the male-side insulating base to form a male-side mating body, and the male-side mating body comprises a male-side joining space and a male-side locking side wall, wherein the male-side terminal joining structure is located within the male-side joining space, and the male-side locking side wall comprises a first male-side locking direction and a second male-side locking direction, and the first male-side locking direction extends along a first male-side locking direction extension line, and the second male-side locking direction extends along a second male-side locking direction extension line, and the first male-side locking direction extension line and the second male-side locking direction extension line can extend and intersect substantially, and the male-side locking side wall also comprises a first male-side locking structure and a second male-side locking structure, wherein the male-side locking side wall guides the female-side connector into the male-side joining space to join with the male-side terminal joining structure; and when the female-side connector enters the male-side joining space, the first male-side locking structure locks the female-side connector in the first male-side locking direction, and the second male-side locking structure locks the female-side connector in the second male-side locking direction, to maintain the joining relationship between the male-side terminal joining structure and the female-side connector.

Preferably, the male-side connector said above, wherein the first male-side locking direction extension line and the second male-side locking direction extension line intersect substantially perpendicularly.

Preferably, the male-side connector said above, wherein the first male-side locking structure and the second male-side locking structure are positioned on the male-side metal shell.

Preferably, the male-side connector said above, wherein the first male-side locking structure is positioned on the male-side metal shell, and the second male-side locking structure is positioned on the male-side insulating base.

Preferably, the male-side connector said above, wherein the male-side locking side wall also comprises a third male-side locking direction, and the third male-side locking direction extends along a third male-side locking direction extension line, and the third male-side locking direction extension line and the second male-side locking direction extension line can extend and intersect substantially with each other, and the male-side locking side wall further comprises a third male-side locking structure, wherein when the female-side connector enters the male-side joining space, the third male-side locking structure locks the female-side connector in the third male-side locking direction to maintain the joining relationship between the male-side terminal joining structure and the female-side connector.

Preferably, the male-side connector said above, wherein the second male-side locking direction extension line and the third male-side locking direction extension line intersect substantially perpendicularly.

Preferably, the male-side connector said above, wherein the third male-side locking structure is positioned on the male-side insulating base.

Preferably, the male-side connector said above, wherein the first male-side locking structure, the second male-side locking structure, and the third male-side locking structure are either recessed structures or protruding structures.

Additionally, the present application provides a connector assembly, comprising: said female-side connector; and said male-side connector; wherein the female-side locking side wall abuts the male-side locking side wall, guiding the female-side terminal joining structure to join with the male-side terminal joining structure; and the first female-side locking structure locks the first male-side locking structure, and the second female-side locking structure locks the second male-side locking structure, to maintain the joining relationship between the male-side terminal joining structure and the female-side terminal joining structure.

Preferably, the connector assembly said above, wherein the first female-side locking structure and the second female-side locking structure are positioned on the female-side metal shell; and the first male-side locking structure and the second male-side locking structure are positioned on the male-side metal shell.

Preferably, the connector assembly said above, wherein the first female-side locking structure is positioned on the female-side metal shell; the second female-side locking structure is positioned on the female-side insulating base; the first male-side locking structure is positioned on the male-side metal shell; and the second male-side locking structure is positioned on the male-side insulating base.

Preferably, the connector assembly said above, wherein the first female-side locking structure and the male-side locking structure are correspondingly recessed structures and protruding structures, respectively; and the second female-side locking structure and the second male-side locking structure are correspondingly recessed structures and protruding structures, respectively.

Furthermore, the present application provides a connector assembly, comprising: said female-side connector; and said male-side connector; wherein the female-side locking side wall abuts the male-side locking side wall, guiding the female-side terminal joining structure to join with the male-side terminal joining structure; and the first female-side locking structure locks the first male-side locking structure, the second female-side locking structure locks the second male-side locking structure, and the third female-side locking structure locks the third male-side locking structure, to maintain the joining relationship between the male-side terminal joining structure and the female-side terminal joining structure.

Preferably, the connector assembly said above, wherein the first female-side locking structure and the second female-side locking structure are positioned on the female-side metal shell; the first male-side locking structure and the second male-side locking structure are positioned on the male-side metal shell; the third female-side locking structure is positioned on either the female-side metal shell or the female-side insulating base; and the third male-side locking structure is positioned on the male-side insulating base.

Preferably, the connector assembly said above, wherein the first female-side locking structure is positioned on the female-side metal shell; the second female-side locking structure is positioned on the female-side insulating base; the first male-side locking structure is positioned on the male-side metal shell; the second male-side locking structure is positioned on the male-side insulating base; the third female-side locking structure is positioned on either the female-side metal shell or the female-side insulating base; and the third male-side locking structure is positioned on the male-side insulating base.

Preferably, the connector assembly said above, wherein the first female-side locking structure and the first male-side locking structure are respectively recessed structures and protruding structures with structurally corresponding configurations; the second female-side locking structure and the second male-side locking structure are respectively recessed structures and protruding structures with structurally corresponding configurations; and the third female-side locking structure and the third male-side locking structure are respectively recessed structures and protruding structures with structurally corresponding configurations.

Furthermore, the present application provides a female-side connector, which enables to join with a male-side connector, and the female-side connector comprises: a female-side conductive terminal, comprising a female-side terminal joining structure; a female-side insulating base, being embedded with the female-side conductive terminal; and a female-side metal shell, being mated with the female-side insulating base, enables the female-side metal shell to mated with the female-side insulating base to form a female-side mating body, and the female-side mating body comprises a female-side joining space and a female-side locking side wall, wherein the female-side terminal joining structure is located within the female-side joining space, and the female-side locking side wall comprises a first female-side locking surface and a second female-side locking surface, and the first female-side locking surface extends along a first female-side locking surface extension line, and the second female-side locking surface extends along a second female-side locking surface extension line, and the first female-side locking surface extension line and the second female-side locking surface extension line can extend and intersect substantially, and the female-side locking side wall also comprises a first female-side locking structure and a second female-side locking structure, and the first female-side locking structure is installed on the first female-side locking surface, and the second female-side locking structure is installed on the second female-side locking surface, wherein the female-side locking side wall guides the male-side connector into the female-side joining space to join with the female-side terminal joining structure; and when the male-side connector enters the female-side joining space, the first female-side locking structure and the second female-side locking structure lock the male-side connector, respectively, to maintain the joining relationship between the female-side terminal joining structure and the male-side connector.

Preferably, the female-side connector said above, wherein the first female-side locking surface extension line and the second female-side locking surface extension line intersect substantially perpendicularly.

Preferably, the female-side connector said above, wherein the first female-side locking surface and the second female-side locking surface are positioned on the female-side metal shell.

Preferably, the female-side connector said above, wherein the first female-side locking surface is located on the female-side metal shell, and the second female-side locking surface is located on the female-side insulating base.

Preferably, the female-side connector said above, wherein the female-side locking side wall also comprises a third female-side locking surface, and the third female-side locking surface extends along a third female-side locking surface extension line, and the third female-side locking surface extension line and the second female-side locking surface extension line can extend and intersect with each other, and the female-side locking side wall further comprises a third female-side locking structure, and the third female-side locking structure is installed on the third female-side locking surface, wherein when the male-side connector enters the female-side joining space, the third female-side locking structure locks the male-side connector to maintain the joining relationship between the female-side terminal joining structure and the male-side connector.

Preferably, the female-side connector said above, wherein the third female-side locking surface extension line and the second female-side locking surface extension line intersect substantially perpendicularly.

Preferably, the female-side connector said above, wherein the third female-side locking surface is located on either the female-side metal shell or the female-side insulating base.

Preferably, the female-side connector said above, wherein the first female-side locking structure, the second female-side locking structure, and the third female-side locking structure are recessed structures or protruding structures.

Preferably, the female-side connector said above, wherein the female-side metal shell comprises a first female-side metal locking sub-shell, a second female-side metal locking sub-shell, and a third female-side metal locking sub-shell, within the female-side mating body, the first female-side metal locking sub-shell, the second female-side metal locking sub-shell, and the third female-side metal locking sub-shell are bent to mate with the female-side insulating base, wherein the first female-side locking surface is located on the first female-side metal locking sub-shell, the second female-side locking surface is located on the second female-side metal locking sub-shell, and the third female-side locking surface is located on the third female-side metal locking sub-shell.

Preferably, the female-side connector said above, wherein the second female-side metal locking sub-shell connects to the third sub-shell, allowing the second female-side metal locking sub-shell connects to the third female-side metal locking sub-shell to form a bent structure that mates with the female-side insulating base.

Furthermore, the present application provides a male-side connector, which enables to join with a male-side connector, and the male-side connector comprises: a male-side conductive terminal, comprising a male-side terminal joining structure; a male-side insulating base, being embedded with the male-side conductive terminal; and a male-side metal shell, being mated with the male-side insulating base, enables the male-side metal shell to mate with the male-side insulating base to form a male-side mating body, and the male-side mating body comprises a male-side joining space and a male-side locking side wall, wherein the male-side terminal joining structure is located within the male-side joining space, and the male-side locking side wall comprises a first male-side locking surface and a second male-side locking surface, and the first male-side locking surface extends along a first male-side locking surface extension line, and the second male-side locking surface extends along a second male-side locking surface extension line, and the first male-side locking surface extension line and the second male-side locking surface extension line can extend and intersect substantially, and the male-side locking side wall also comprises a first male-side locking structure and a second male-side locking structure, and the first male-side locking structure is installed on the first male-side locking surface, and the second male-side locking structure is installed on the second male-side locking surface, wherein the male-side locking side wall guides the female-side connector into the male-side joining space to join with the male-side terminal joining structure; and when the female-side connector enters the male-side joining space, the first male-side locking structure and the second male-side locking structure lock the female-side connector, respectively, to maintain the joining relationship between the male-side terminal joining structure and the female-side connector.

Preferably, the male-side connector said above, wherein the first male-side locking surface extension line and the second male-side locking surface extension line intersect substantially perpendicularly.

Preferably, the female-side connector said above, wherein the first male-side locking surface and the second male-side locking surface are positioned on the male-side metal shell.

Preferably, the male-side connector said above, wherein the first male-side locking surface is located on the male-side metal shell, and the second male-side locking surface is located on the male-side insulating base.

Preferably, the male-side connector said above, wherein the male-side locking side wall also comprises a third male-side locking surface, and the third male-side locking surface extends along a third male-side locking surface extension line, and the third male-side locking surface extension line and the second male-side locking surface extension line can extend and intersect with each other, and the male-side locking side wall further comprises a third male-side locking structure, and the third male-side locking structure is installed on the third male-side locking surface, wherein when the female-side connector enters the male-side joining space, the third male-side locking structure locks the female-side connector to maintain the joining relationship between the male-side terminal joining structure and the female-side connector.

Preferably, the male-side connector said above, wherein the third male-side locking surface extension line and the second male-side locking surface extension line intersect substantially perpendicularly.

Preferably, the male-side connector said above, wherein the third male-side locking surface is located on the male-side insulating base.

Preferably, the male-side connector said above, wherein the first male-side locking structure, the second male-side locking structure, and the third male-side locking structure are recessed structures or protruding structures.

Furthermore, the present application provides a connector assembly, comprising: said female-side connector; and said male-side connector; wherein the female-side locking side wall abuts the male-side locking side wall, guiding the female-side terminal joining structure to join with the male-side terminal joining structure; and the first female-side locking structure locks the first male-side locking structure, the second female-side locking structure locks the second male-side locking structure, to maintain the joining relationship between the male-side terminal joining structure and the female-side terminal joining structure.

Preferably, the connector assembly said above, wherein the first female-side locking surface and the second female-side locking surface are positioned on the female-side metal shell; the first male-side locking surface and the second male-side locking surface are positioned on the male-side metal shell.

Preferably, the connector assembly said above, wherein the first female-side locking surface is positioned on the female-side metal shell; the second female-side locking surface is positioned on the female-side insulating base; the first male-side locking surface is positioned on the male-side metal shell; the second male-side locking surface is positioned on the male-side insulating base.

Preferably, the connector assembly said above, wherein the first female-side locking structure and the first male-side locking structure are respectively recessed structures and protruding structures with structurally corresponding configurations; the second female-side locking structure and the second male-side locking structure are respectively recessed structures and protruding structures with structurally corresponding configurations.

Preferably, the connector assembly said above, comprising: a female-side connector said above; and a male-side connector said above; wherein the female-side locking side wall abuts the male-side locking side wall, guiding the female-side terminal joining structure to join with the male-side terminal joining structure; and the first female-side locking structure locks the first male-side locking structure, the second female-side locking structure locks the second male-side locking structure, and the third female-side locking structure locks the third male-side locking structure, to maintain the joining relationship between the male-side terminal joining structure and the female-side terminal joining structure.

Preferably, the connector assembly said above, the first female-side locking surface and the second female-side locking surface are located on the female-side metal shell; the first male-side locking surface and the second male-side locking surface on the male-side metal shell; the third female-side locking surface is on either the female-side metal shell or female-side insulating base; and the third male-side locking surface is on the male-side insulating base.

Preferably, the connector assembly said above, the first female-side locking surface is located on the female-side metal shell; the second female-side locking surface is on the female-side insulating base; the first male-side locking surface is located on the male-side metal shell; the third female-side locking surface is on the female-side metal shell or the female-side insulating base; the third male-side locking surface is on the male-side insulating base.

Preferably, the connector assembly said above, wherein the first female-side locking structure and the first male-side locking structure are respectively recessed structures and protruding structures with structurally corresponding configurations; the second female-side locking structure and the second male-side locking structure are respectively recessed structures and protruding structures with structurally corresponding configurations; and the third female-side locking structure and the third male-side locking structure are respectively recessed structures and protruding structures with structurally corresponding configurations.

Compared to prior art, this application provides a connector assembly and its female-side connector and male-side connector, wherein the female-side connector and the male-side connector are equipped with a metal shell and an insulating base, wherein the metal shell can mate with the insulating base to form a locking side wall, which enables the male-side connector to lock the female-side connector, thereby preventing the male-side connector from detaching from the joined female-side connector to address the technical issue of the male-side connector easily detaching from the joined female-side connector, ensuring that the signal transmission function between the female-side connector and male-side connector meet expectations. As a result, this connector assembly can be widely applied to various electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view showing a first viewing angle of the connector assembly according to one embodiment of the present application.

FIG. 2 is a three-dimensional schematic view of partial components of the connector assembly in one embodiment of the present application.

FIG. 3 is a three-dimensional schematic view of partial components of a female-side connector in one embodiment of the present application.

FIG. 4 is a top schematic view of the female-side connector in one embodiment of the present application.

FIG. 5 is a top schematic view of the female-side connector in one embodiment of the present application.

FIG. 6 is a top schematic view of the female-side connector in one embodiment of the present application.

FIG. 7 is a sectional schematic view along line AA of partial components of the female-side connector shown in FIG. 6.

FIG. 8 is a sectional schematic view along line BB of partial components of the female-side connector shown in FIG. 6.

FIG. 9 is a three-dimensional schematic view of partial components of a male-side connector in one embodiment of the present application.

FIG. 10 is a top schematic view of the male-side connector in one embodiment of the present application.

FIG. 11 is a top schematic view of the male-side connector in one embodiment of the present application.

FIG. 12 is a side schematic view of the male-side connector in one embodiment of the present application.

FIG. 13 is a three-dimensional schematic view showing a first viewing angle of the female-side connector in one embodiment of the present application.

FIG. 14 is a three-dimensional schematic view of partial components of the female-side connector in one embodiment of the present application.

FIG. 15 is a three-dimensional schematic view showing a first viewing angle of the female-side connector in one embodiment of the present application.

FIG. 16 is a three-dimensional schematic view showing a first viewing angle of the female-side connector in one embodiment of the present application.

FIG. 17 is a three-dimensional schematic view showing a first viewing angle of the female-side connector in one embodiment of the present application.

FIG. 18 is a three-dimensional schematic view of partial components of the female-side connector in one embodiment of the present application.

FIG. 19 is a three-dimensional schematic view showing a first viewing angle of the female-side connector in one embodiment of the present application.

FIG. 20 is a three-dimensional schematic view of partial components of the female-side connector in one embodiment of the present application.

FIG. 21 is a three-dimensional schematic view showing a first viewing angle of the female-side connector in one embodiment of the present application.

FIG. 22 is a three-dimensional schematic view of partial components of the female-side connector in one embodiment of the present application.

FIG. 23 is a three-dimensional schematic view showing a first viewing angle of the female-side connector in one embodiment of the present application.

FIG. 24 is a three-dimensional schematic view of partial components of the female-side connector in one embodiment of the present application.

FIG. 25 is a three-dimensional schematic view showing a first viewing angle of the male-side connector in one embodiment of the present application.

FIG. 26 is a three-dimensional schematic view of partial components of the male-side connector in one embodiment of the present application.

FIG. 27 is a three-dimensional schematic view showing a first viewing angle of the male-side connector in one embodiment of the present application.

FIG. 28 is a three-dimensional schematic view showing a first viewing angle of the male-side connector in one embodiment of the present application.

FIG. 29 is a three-dimensional schematic view showing a first viewing angle of the male-side connector in one embodiment of the present application.

FIG. 30 is a three-dimensional schematic view showing a first viewing angle of the male-side connector in one embodiment of the present application.

FIG. 31 is a three-dimensional schematic view showing a first viewing angle of the male-side connector in one embodiment of the present application.

FIG. 32 is a three-dimensional schematic view of partial components of the male-side connector in one embodiment of the present application.

FIG. 33 is a three-dimensional schematic view showing a first viewing angle of the male-side connector in one embodiment of the present application.

FIG. 34 is a three-dimensional schematic view of partial components of the male-side connector in one embodiment of the present application.

### DETAILED DESCRIPTION THE PREFERRED OF EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

This application provides a connector assembly and its female-side connector and male-side connector. The female-side and male-side connectors are equipped with a metal shell and an insulating base, wherein the metal shell can mate with the insulating base to form a locking side wall. Through the locking side wall, the male-side connector locks the female-side connector, thus preventing the male-side connector from detaching from the joined female-side connector, effectively addressing the technical issue of easy detachment of the male-side connector from the female-side connector.

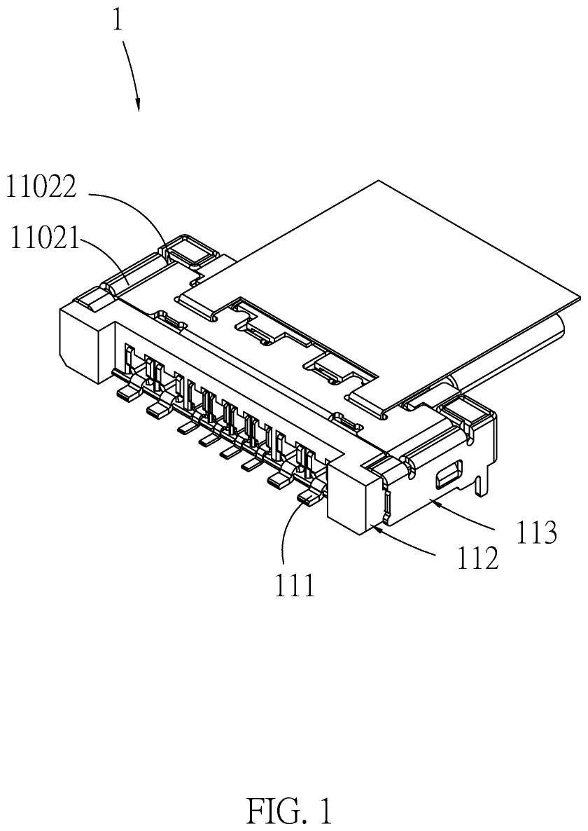

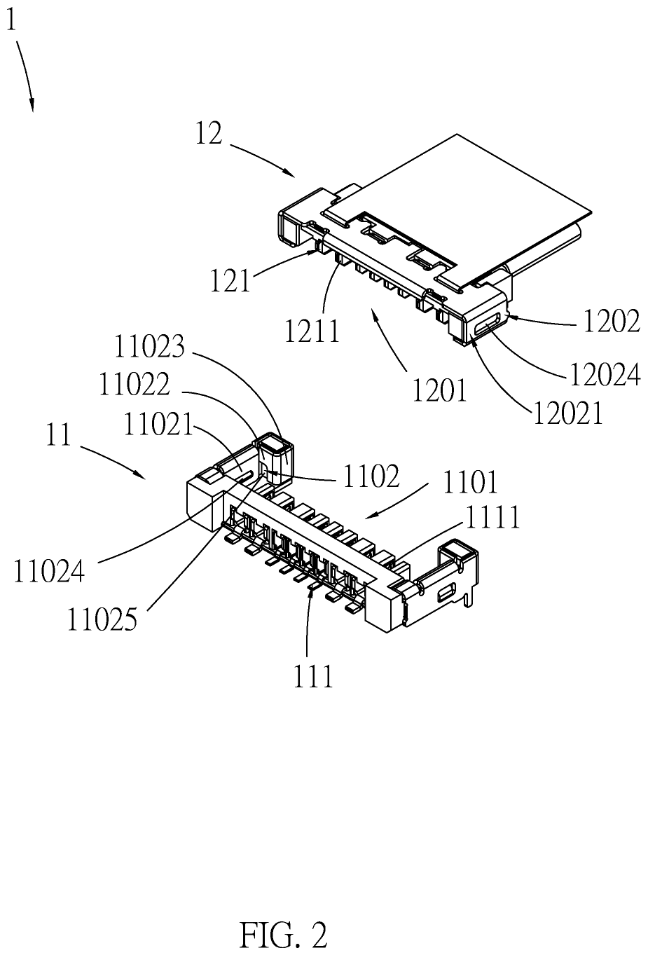

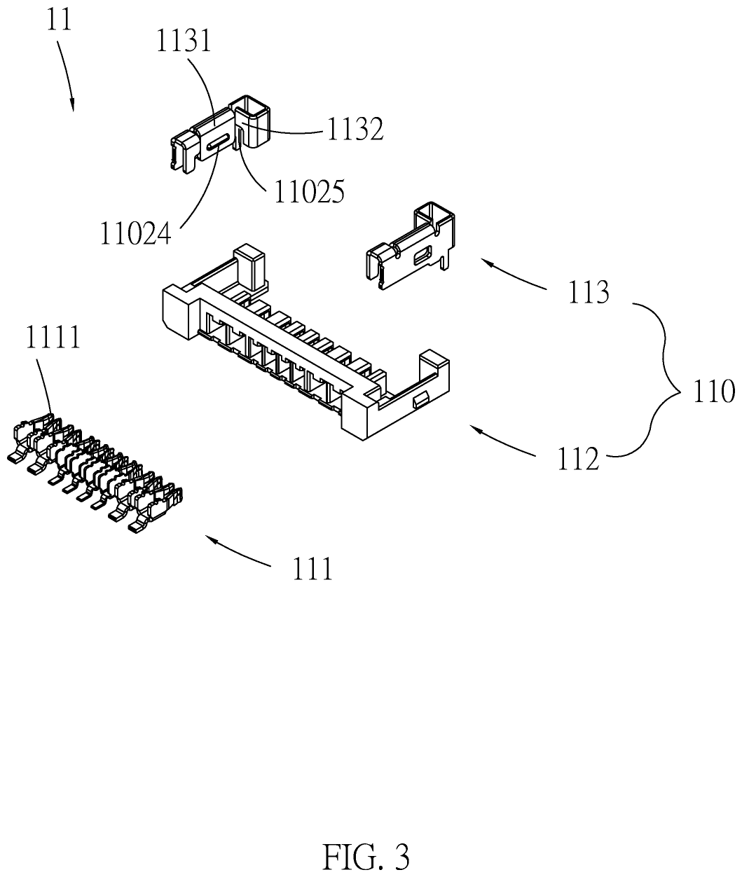

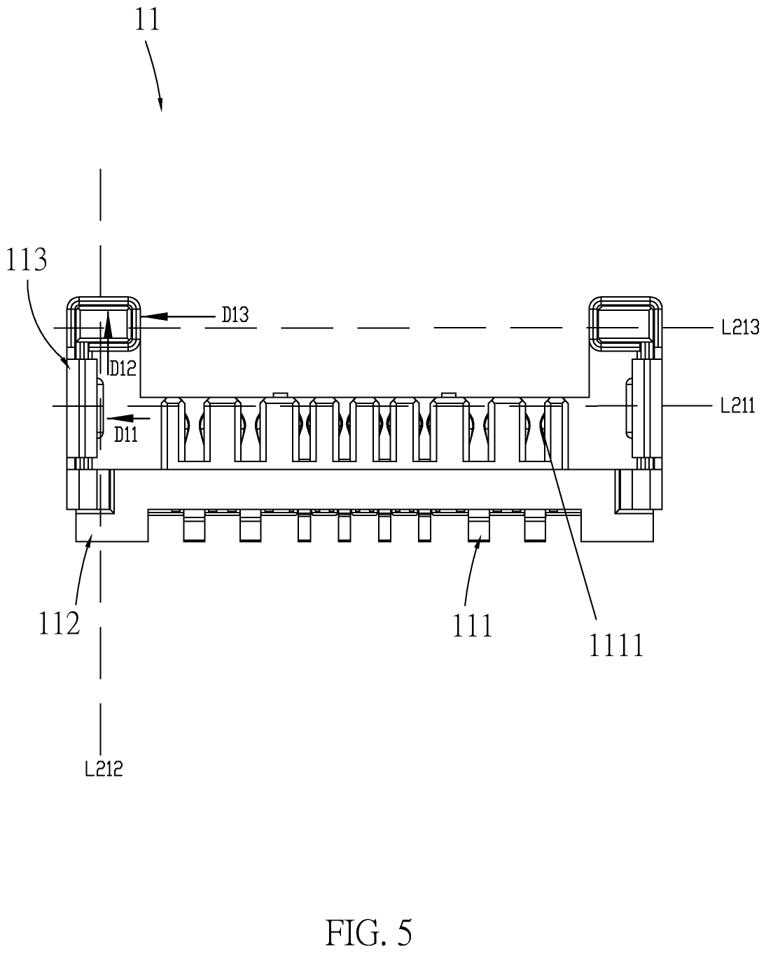

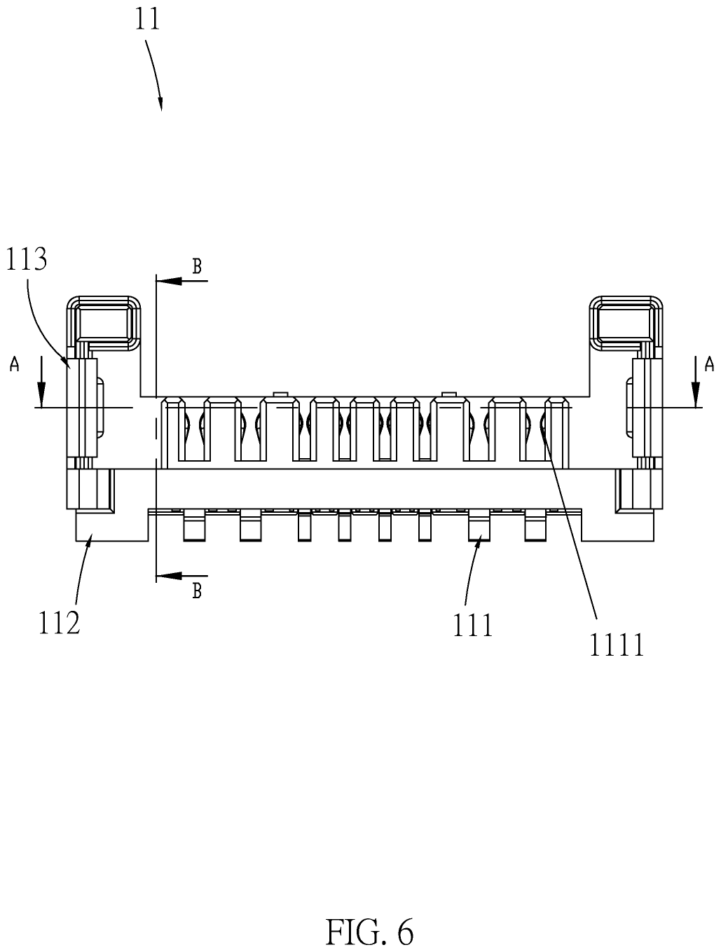

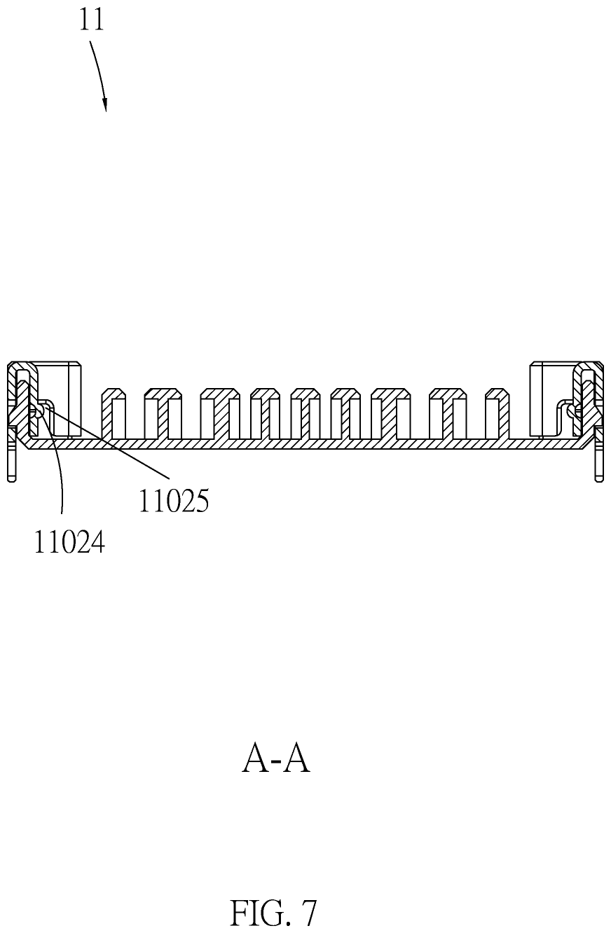

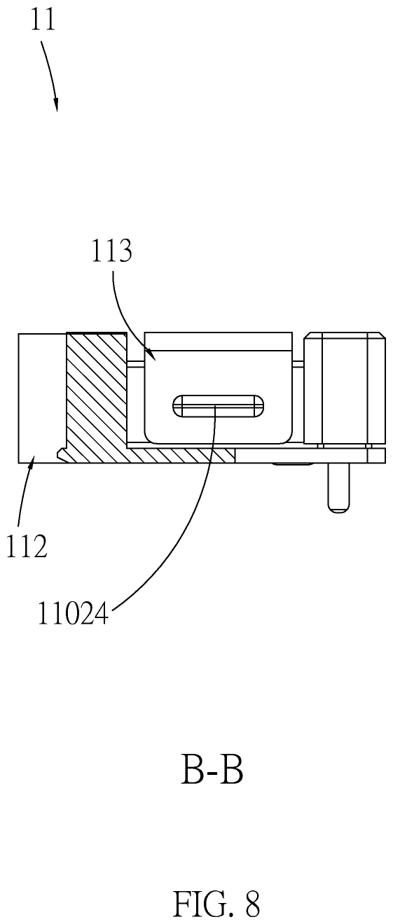

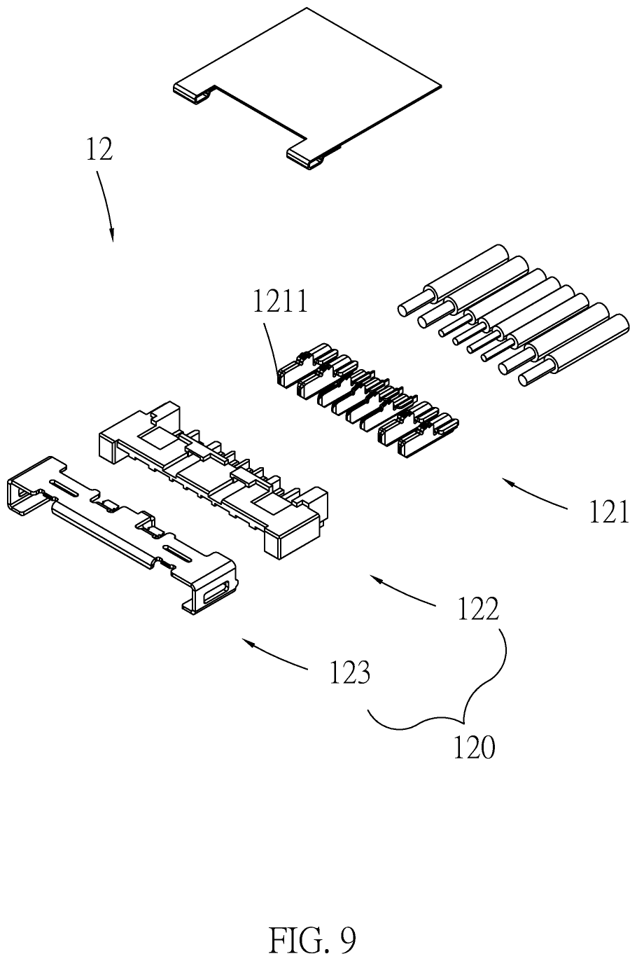

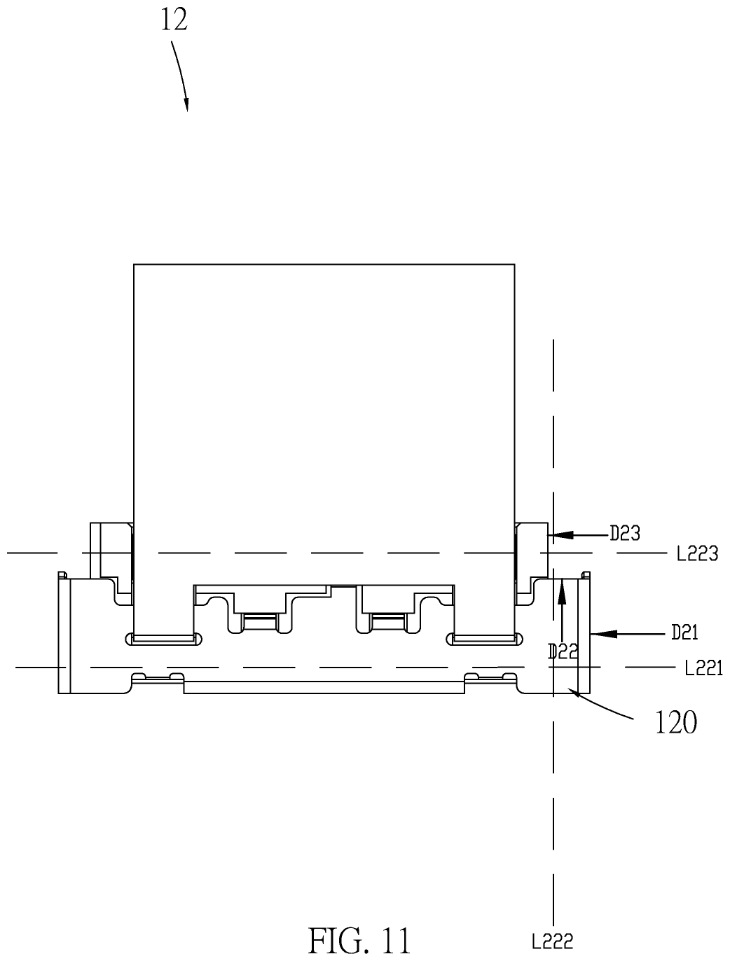

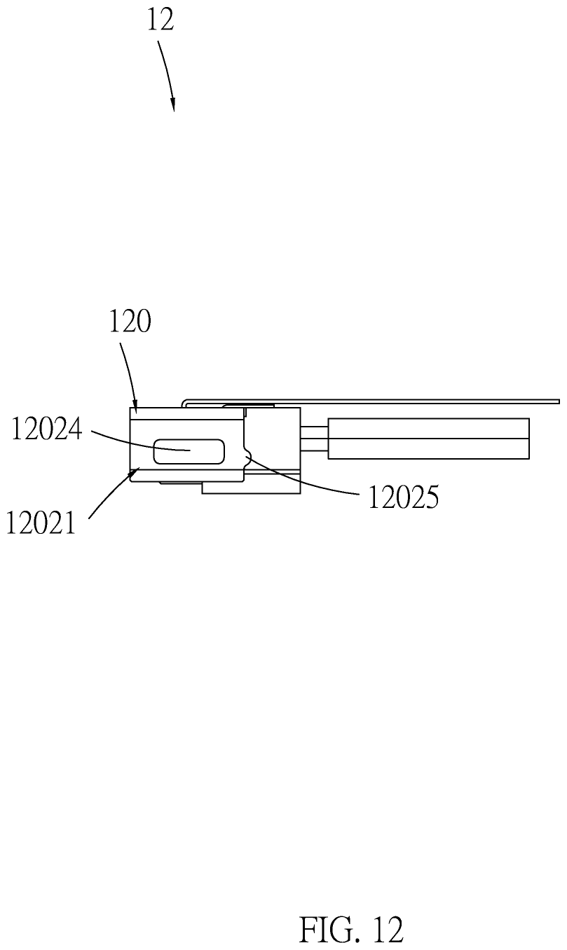

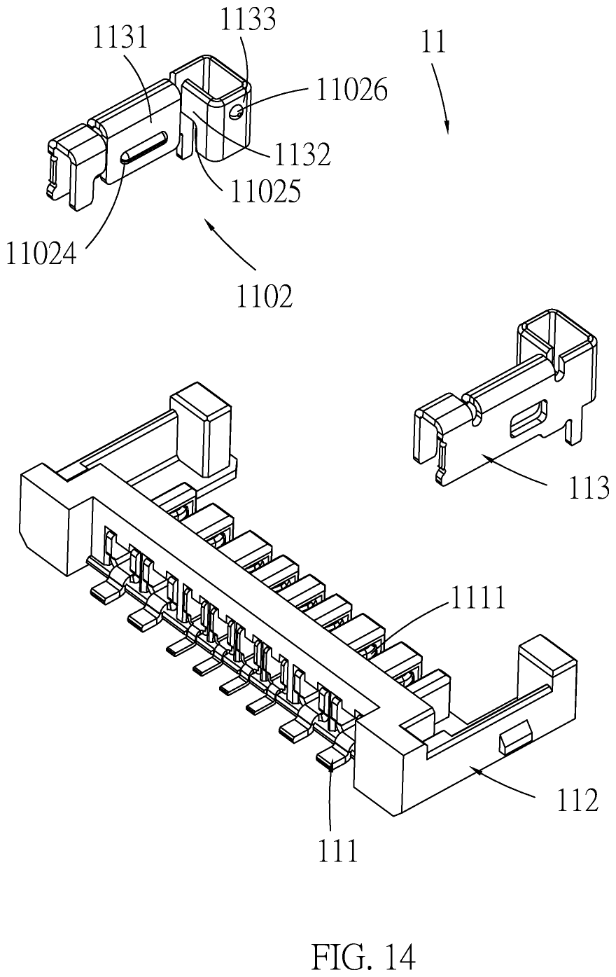

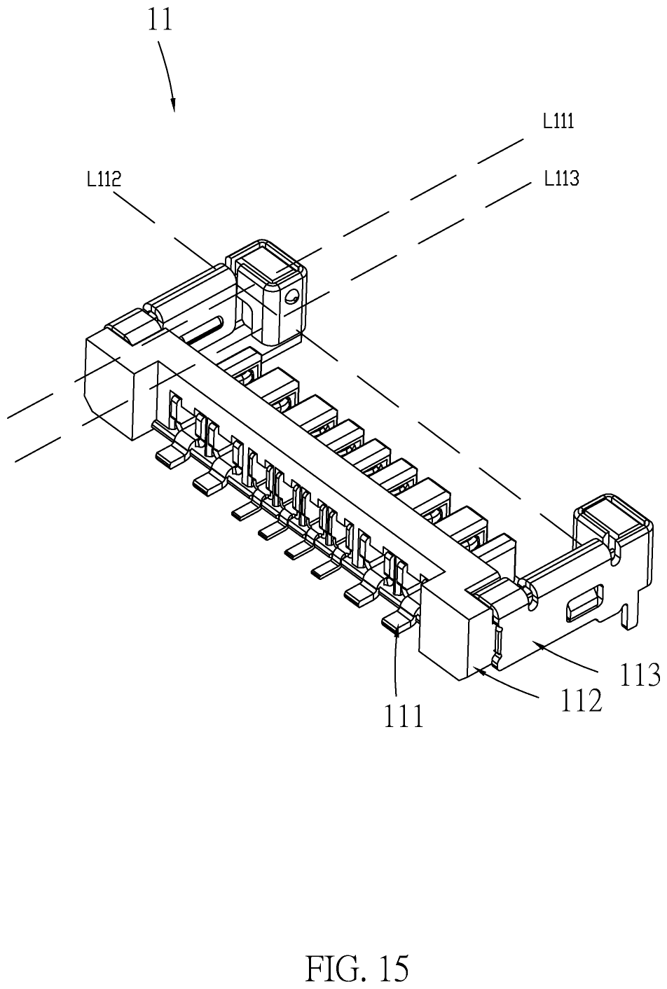

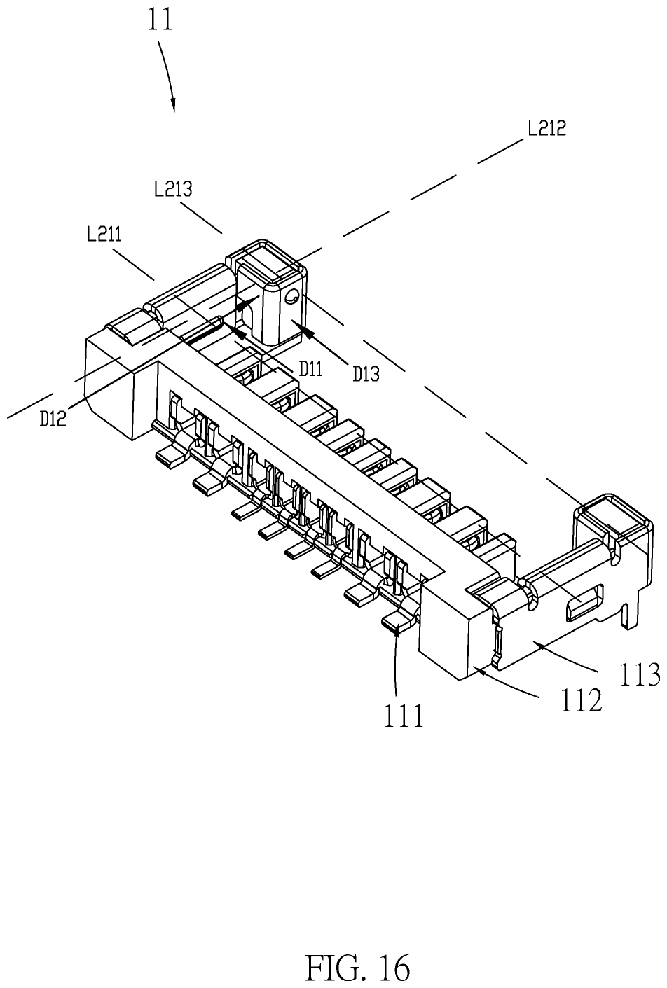

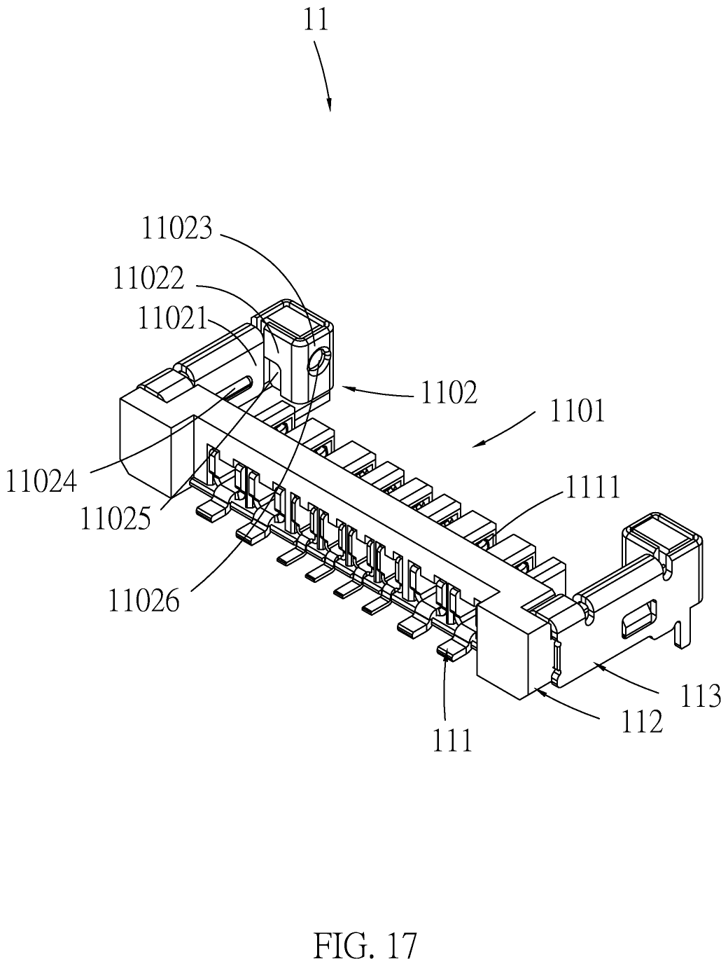

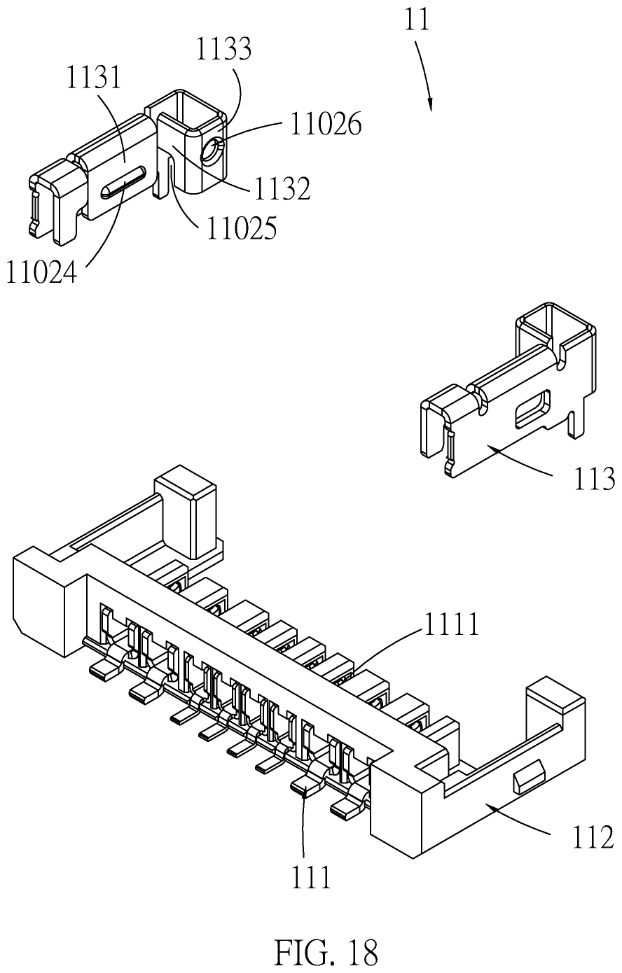

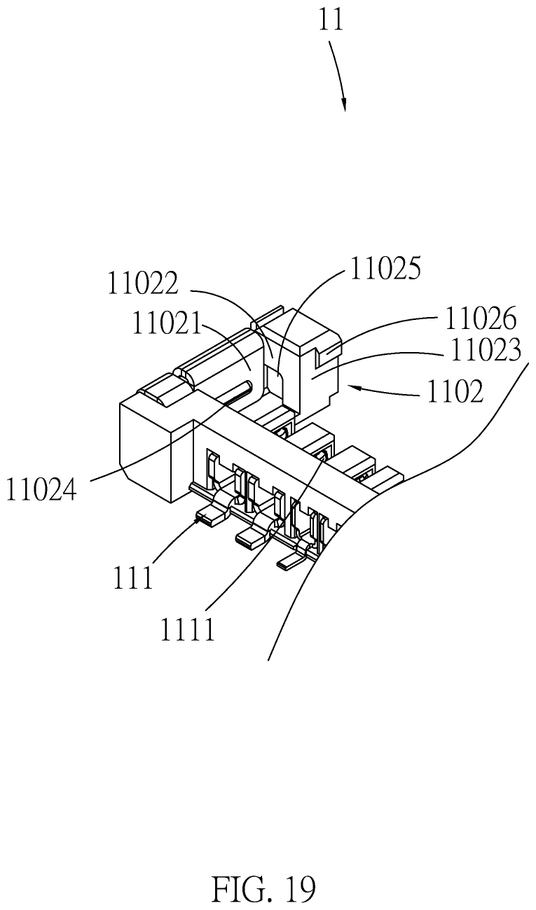

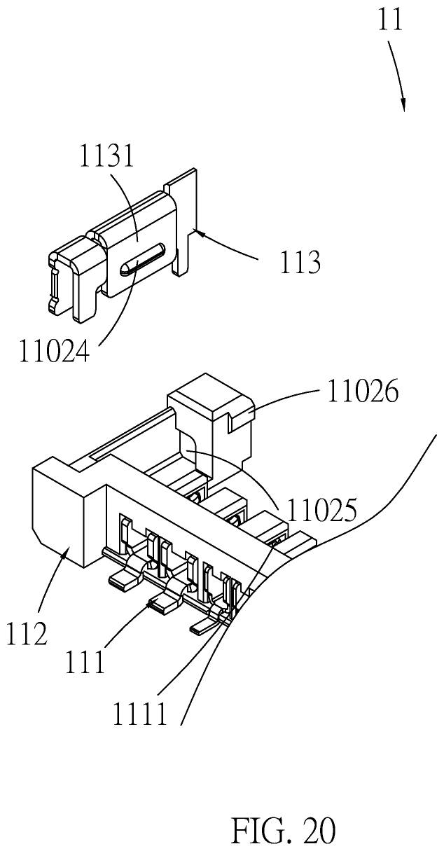

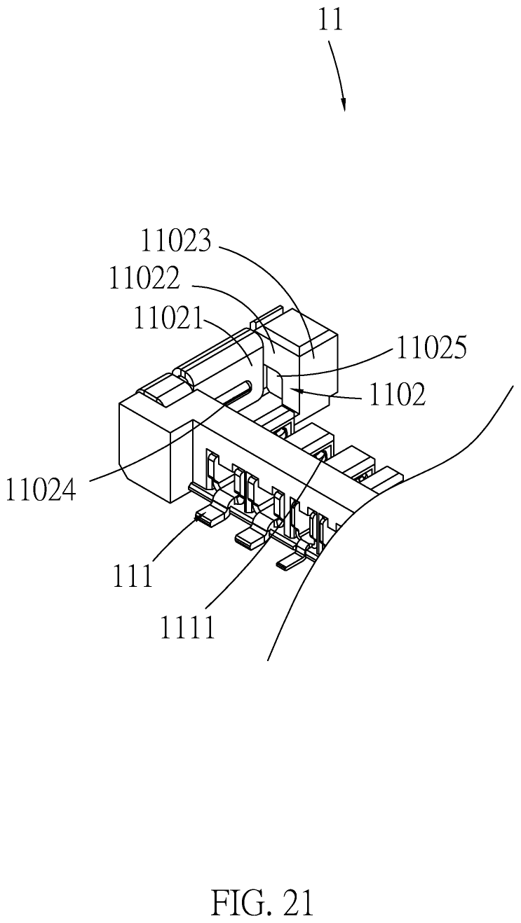

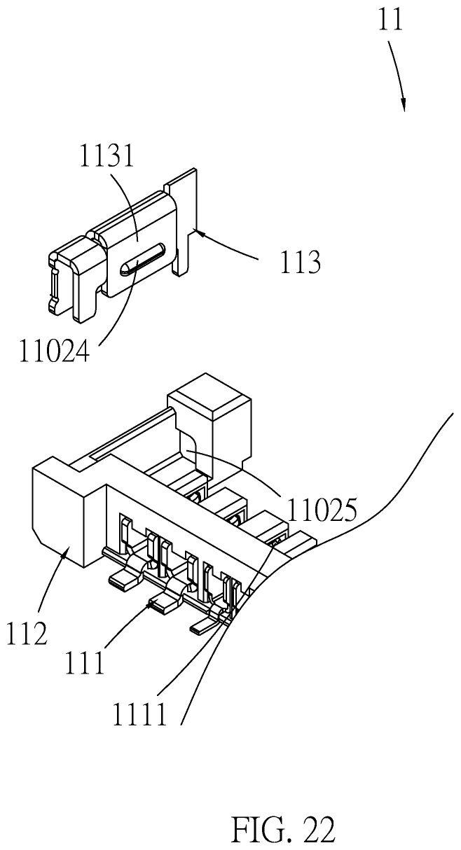

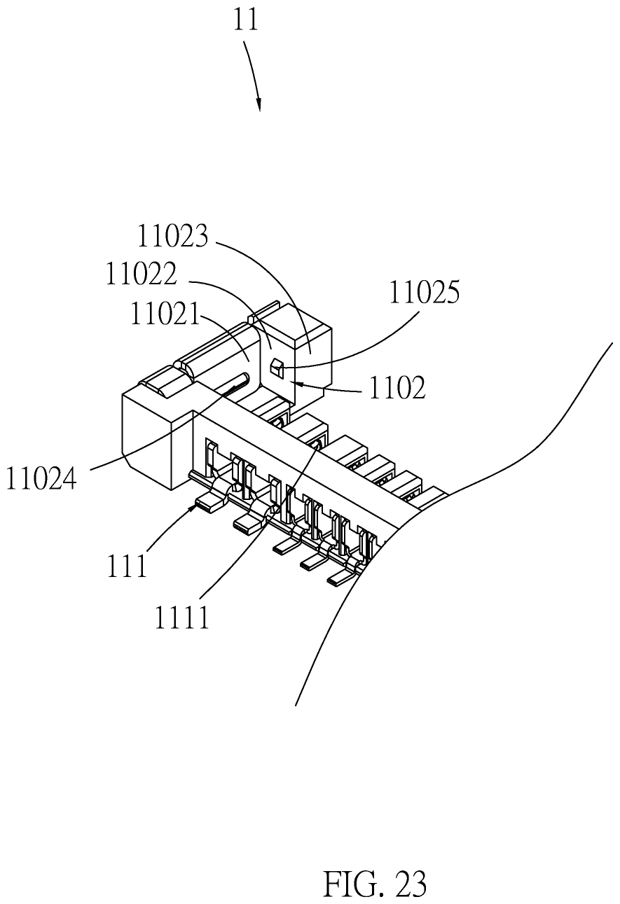

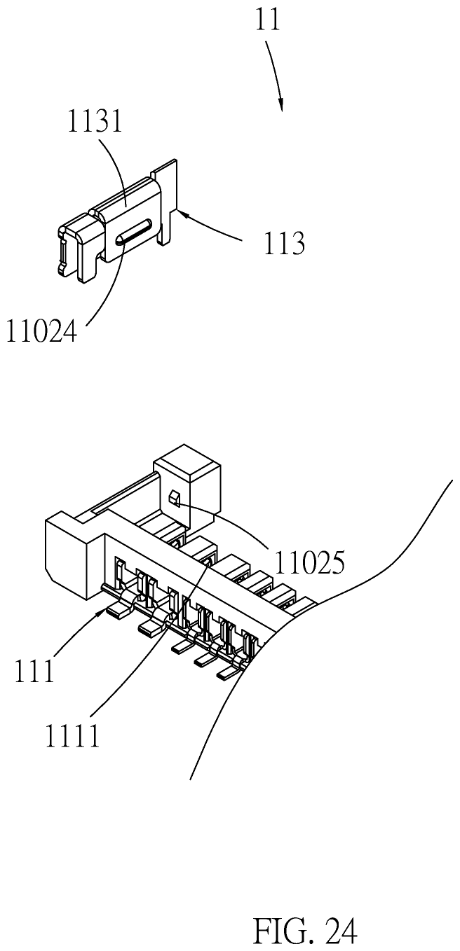

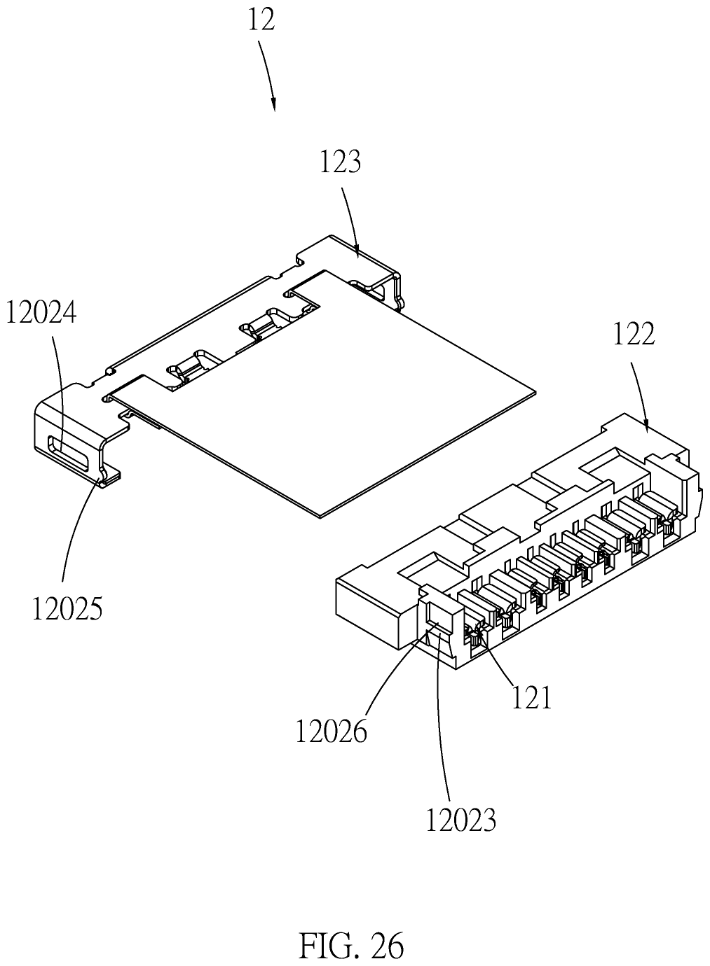

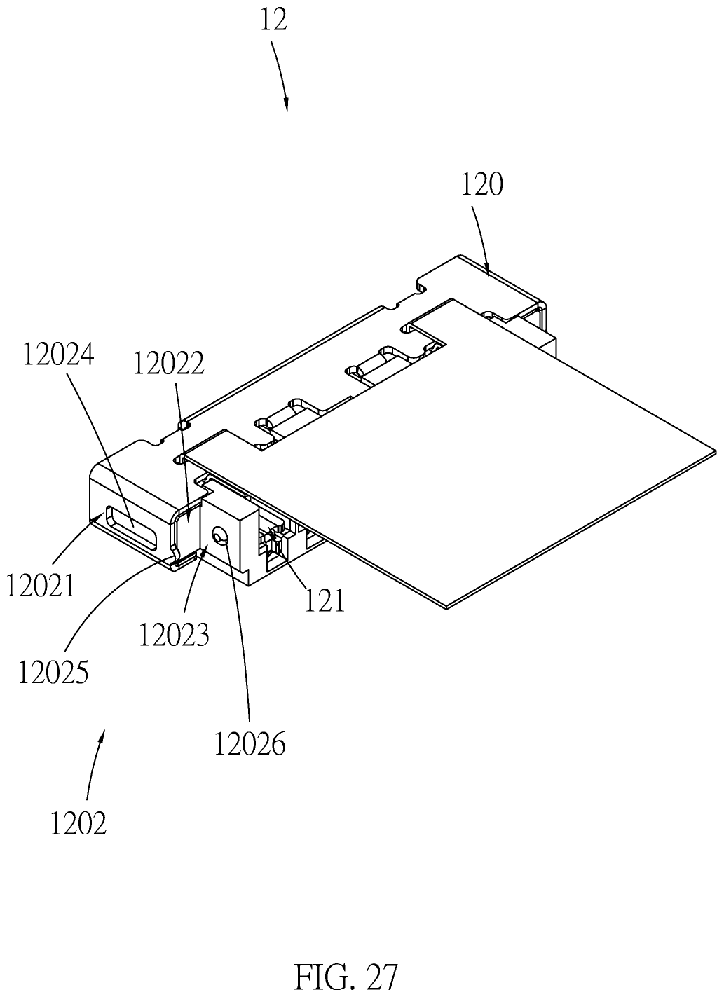

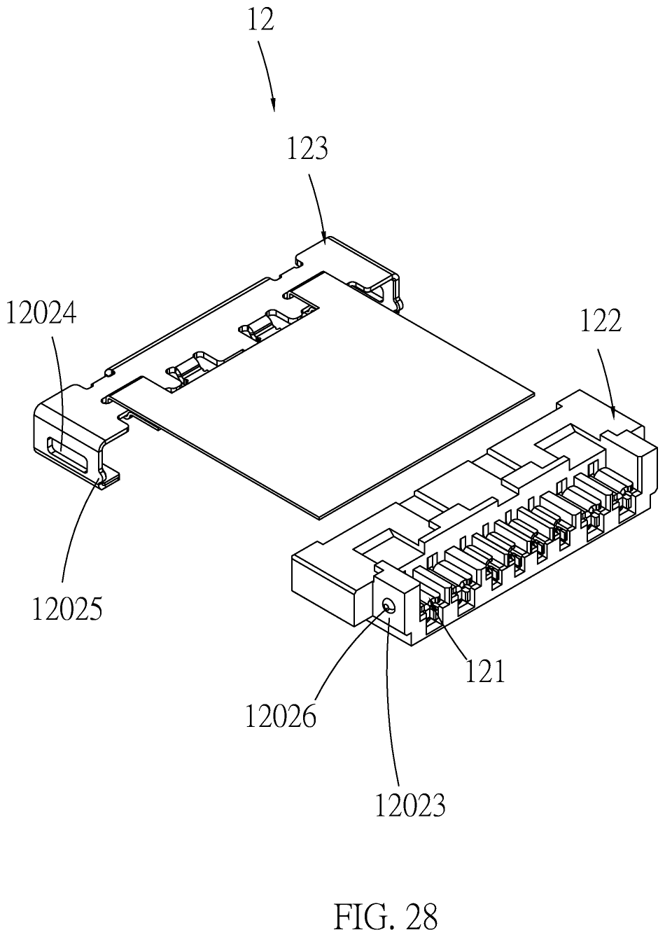

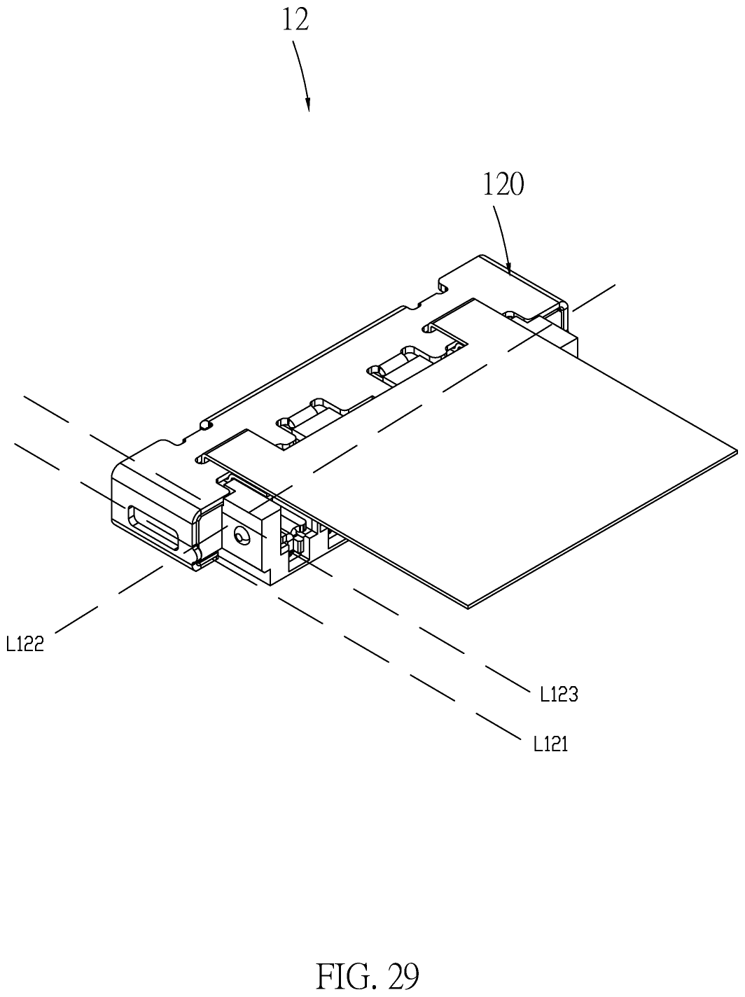

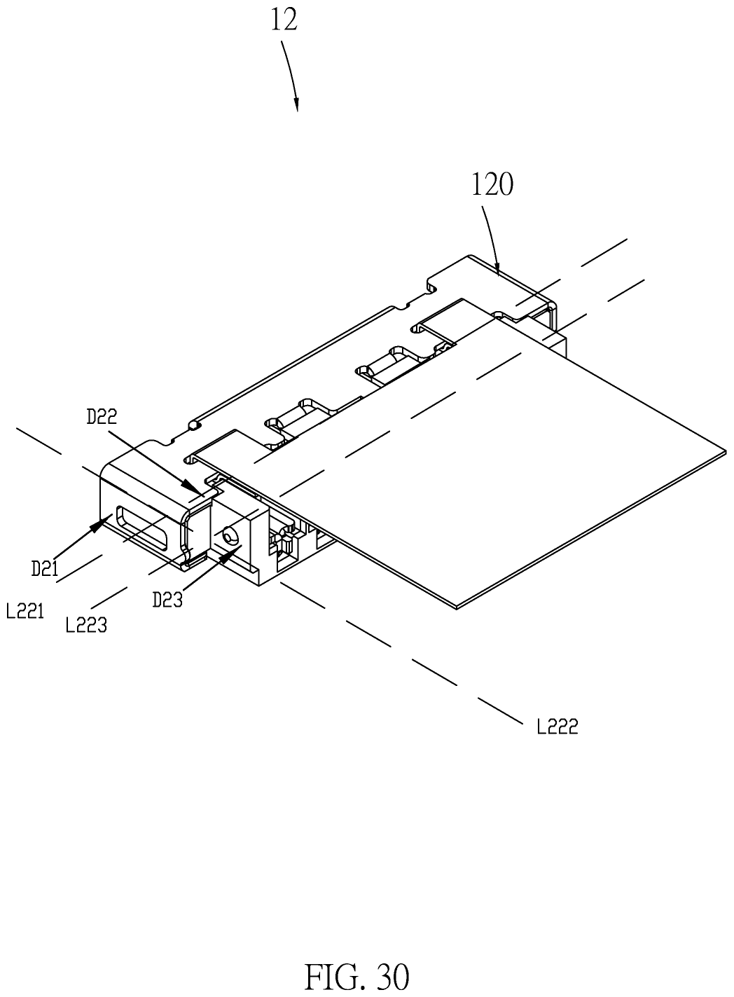

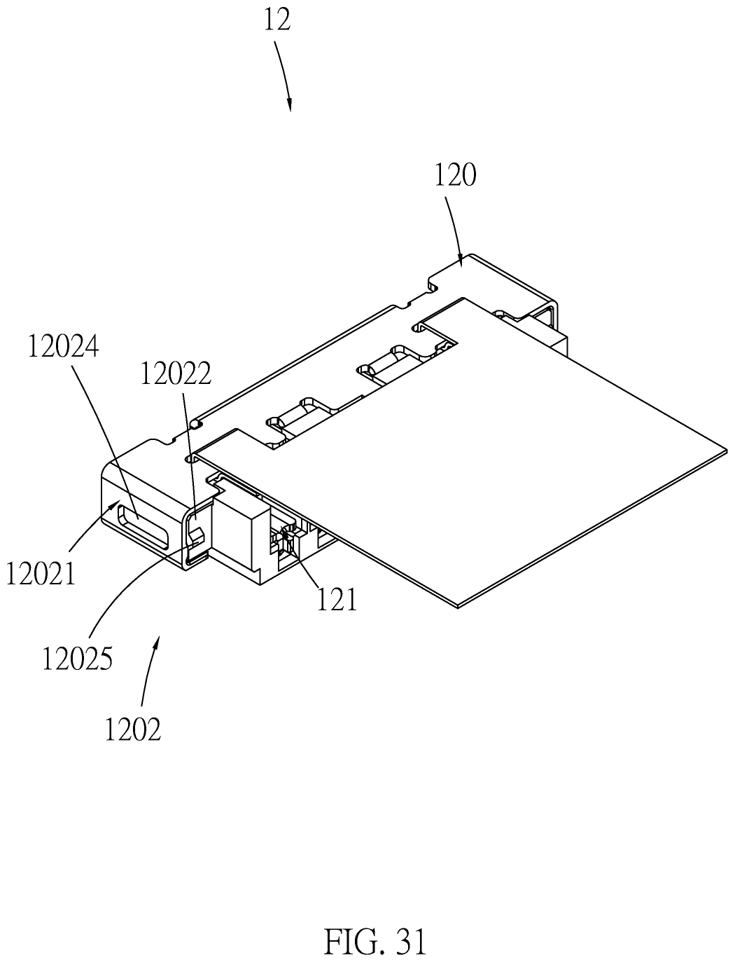

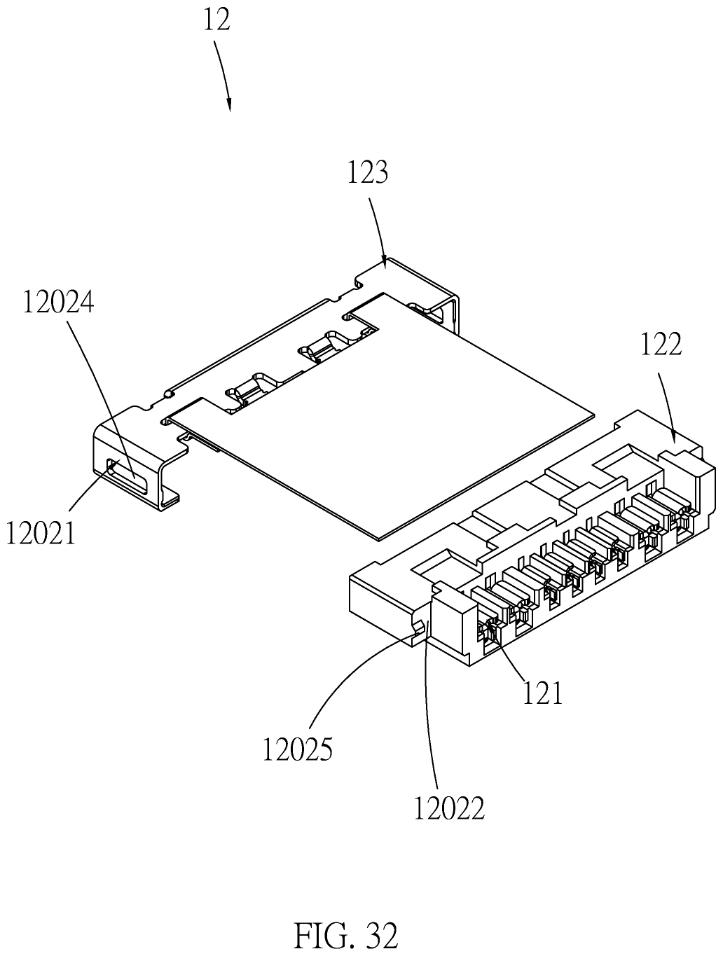

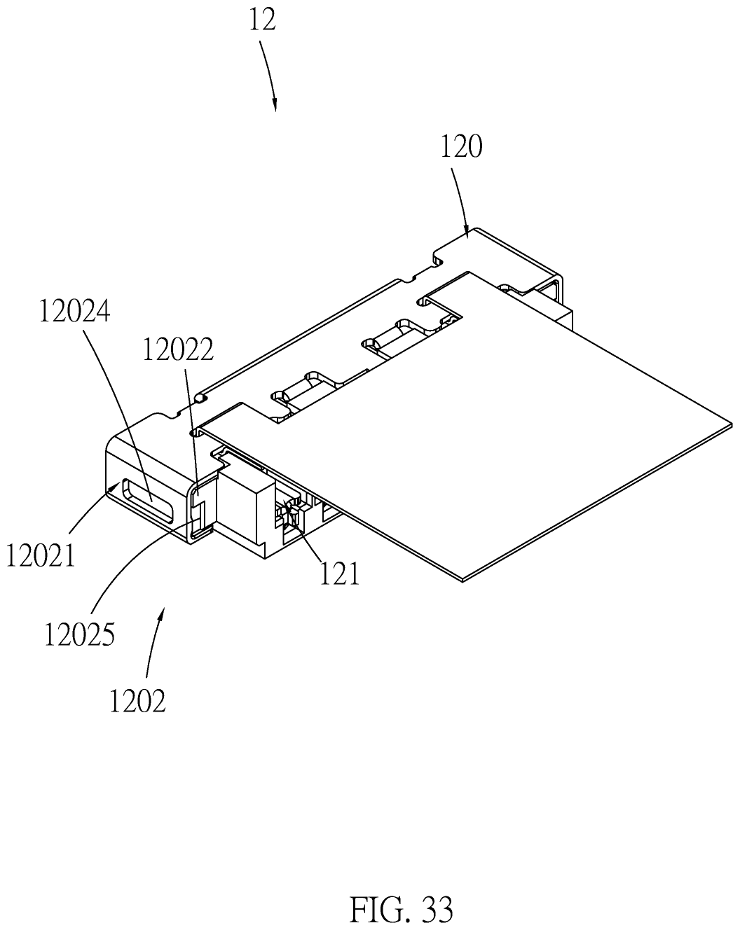

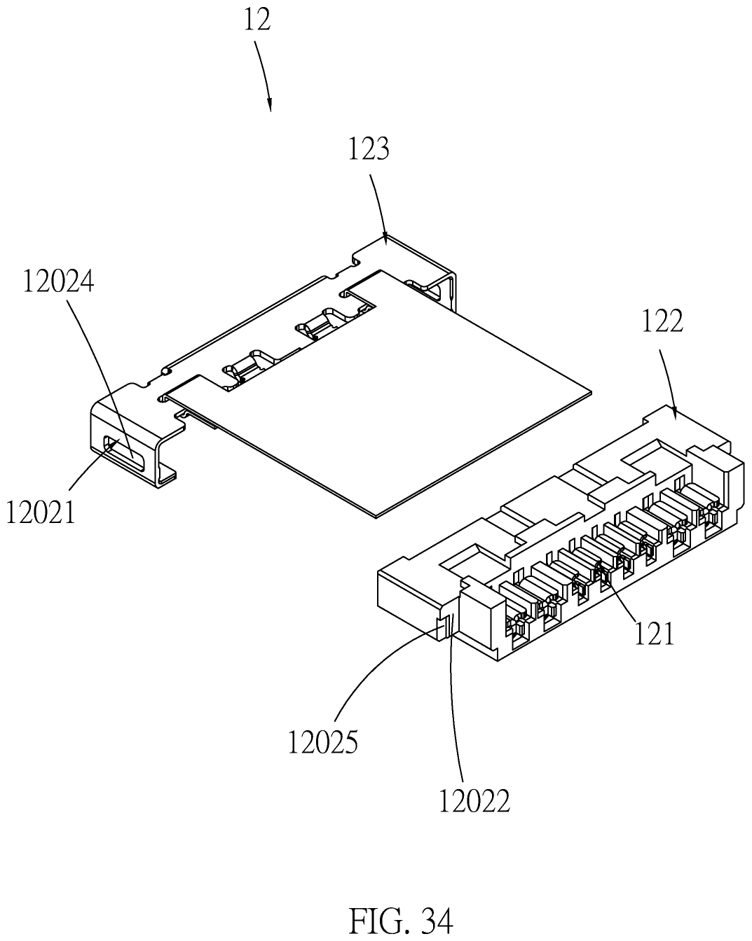

For a comprehensive understanding of the technical concepts of the connector assembly and its female-side connector and male-side connector, refer to the embodiment illustrations in FIGS. 1 to 34.

In the embodiments shown in FIGS. 1 to 34, the female-side connector 11 can be joined with the male-side connector 12 to form the connector assembly 1, which can be applied to various electronic devices for signal transmission.

In these embodiments, the female-side connector 11 comprises a female-side conductive terminal 111, a female-side insulating base 112, and a female-side metal shell 113. The female-side conductive terminal 111 comprises a female-side terminal joining structure 1111. The female-side insulating base 112 is made from an insulating material capable of embedding the female-side conductive terminal 111. The female-side metal shell 113 is a shell made, for example, from a bent sheet metal material, and the female-side metal shell 113 mates with the female-side insulating base 112, enabling the female-side metal shell 113 to be joined with the female-side insulating base 112 to form a female-side mating body 110.

The female-side mating body 110 comprises a female-side joining space 1101 and a female-side locking side wall 1102. Notably, the female-side terminal joining structure 1111 is located within the female-side joining space 1101. The female-side locking side wall 1102 comprises a first female-side locking surface 11021, a second female-side locking surface 11022, a third female-side locking surface 11023, a first female-side locking direction D11, a second female-side locking direction D12, and a third female-side locking direction D13. The first female-side locking surface 11021 extends along the first female-side locking surface extension line L111, the second female-side locking surface 11022 extends along the second female-side locking surface extension line L112, and the third female-side locking surface 11023 extends along the third female-side locking surface extension line L113. The first female-side locking direction D11 extends along the first female-side locking direction extension line L211, the second female-side locking direction D12 extends along the second female-side locking direction extension line L212, and the third female-side locking direction D13 extends along the third female-side locking direction extension line L213.

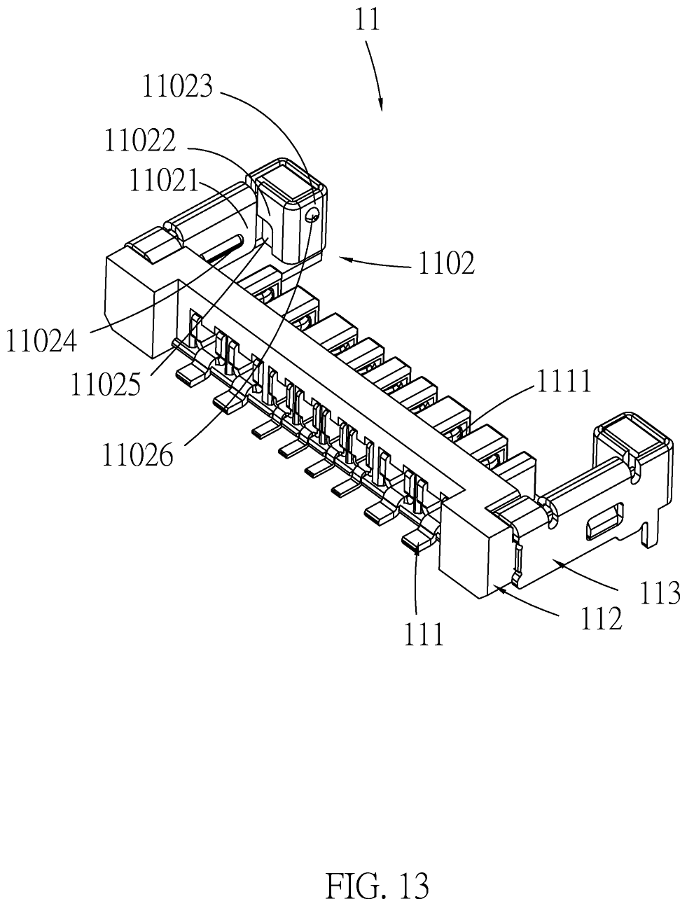

As shown in FIGS. 13 to 20, the first female-side locking surface 11021, the second female-side locking surface 11022 and the third female-side locking surface 11023 are located on the female-side metal shell 113. However, this is not limiting, as the second female-side locking surface 11022 may alternatively be located on the female-side insulating base 112, and the third female-side locking surface 11023 may also be located on the female-side insulating base 112.

In the above embodiments, the first female-side locking surface extension line L111 and the second female-side locking surface extension line L112 can extend to intersect substantially, and the third female-side locking surface extension line L113 and the second female-side locking surface extension line L112 can extend to intersect substantially. The first female-side locking direction extension line L211 and the second female-side locking direction extension line L212 can extend to intersect substantially, and the third female-side locking direction extension line L213 and the second female-side locking direction extension line L212 can extend to intersect substantially.

Additionally, the female-side locking side wall 1102 comprises a first female-side locking structure 11024, a second female-side locking structure 11025, and a third female-side locking structure 11026. The first female-side locking structure 11024 is located on the first female-side locking surface 11021, the second female-side locking structure 11025 is located on the second female-side locking surface 11022, and the third female-side locking structure 11026 is located on the female-side locking surface 11023.

Notably, in these embodiments, the first female-side locking structure 11024, the second female-side locking structure 11025, and the third female-side locking structure 11026 are either recessed structures or protruding structures, allowing for a reduction in the size of the female-side connector 11, thereby enabling the electronic device using the female-side connector 11 to continue developing towards thinner and smaller.

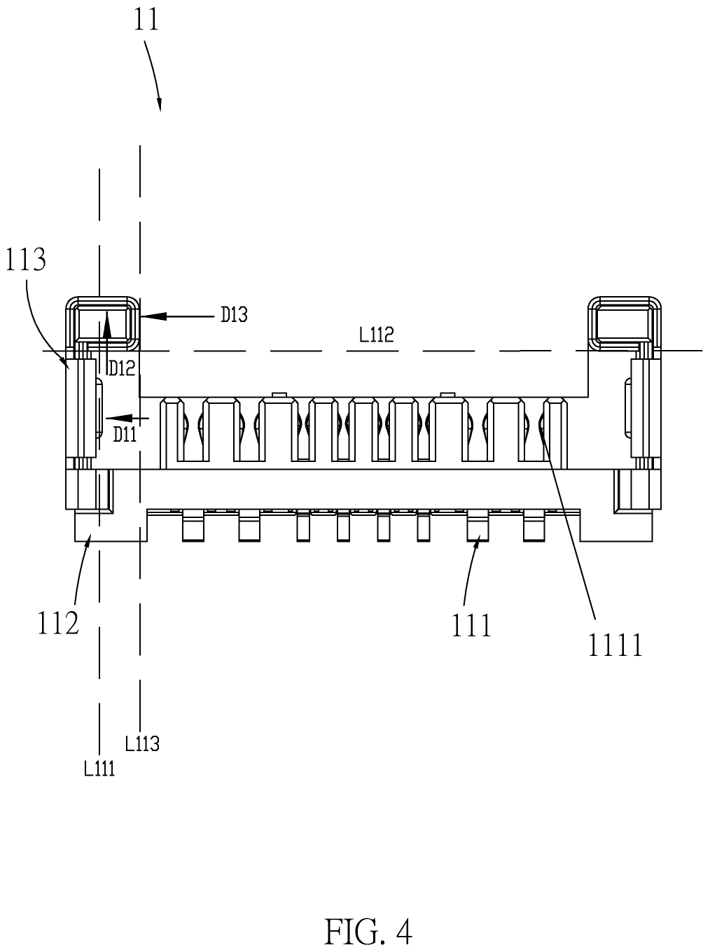

As shown in FIGS. 4 to 5 and FIGS. 15 to 16, the first female-side locking surface extension line L111 and the second female-side locking surface extension line L112 intersect substantially perpendicularly, and the third female-side locking surface extension line L113 intersects substantially perpendicularly with the second female-side locking surface extension line L112. Similarly, the first female-side locking direction extension line L211 and the second female-side locking direction extension line L212 intersect substantially perpendicularly, and the third female-side direction extension line L213 intersects substantially locking perpendicularly with the second female-side locking direction extension line L212. However, this configuration is not limiting; the first female-side locking surface extension line L111 and the second female-side locking surface extension line L112 may also optionally be non-substantially perpendicular to each other. The third female-side locking surface extension line L113 and the second female-side locking surface extension line L112 may also optionally be non-substantially perpendicular to each other. The first female-side locking direction extension line L211 and the second female-side locking direction extension line L212 may also optionally be non-substantially perpendicular to each other. The third female-side locking direction extension line L213 and the second female-side locking direction extension line L212 may also optionally be non-substantially perpendicular to each other.

As shown in FIGS. 13 to 20, the female-side metal shell 113 comprises a first female-side metal locking sub-shell 1131, a second female-side metal locking sub-shell 1132, and a third female-side metal locking sub-shell 1133. In the female-side mating body 110, the first female-side metal locking sub-shell 1131, the second female-side metal locking sub-shell 1132, and the third female-side metal locking sub-shell 1133 are respectively bent and mated to the female-side insulating base 112. Notably, the first female-side locking surface 11021 is located on the first female-side metal locking sub-shell 1131, the second female-side locking surface 11022 is located on the second female-side metal locking sub-shell 1132, and the third female-side locking surface 11023 is located on the third female-side metal locking sub-shell 1133.

Additionally, the second female-side metal locking sub-shell 1132 may be connected to the third female-side metal locking sub-shell 1133, allowing the second female-side metal locking sub-shell 1132 and the third female-side metal locking sub-shell 1133 to form a bendable body capable of mating with the female-side insulating base 112.

In these embodiments, the male-side connector 12 comprises a male-side conductive terminal 121, a male-side insulating base 122, and a male-side metal shell 123. The male-side conductive terminal 121 comprises a male-side terminal joining structure 1211. The male-side insulating base 122 embeds the male-side conductive terminal 121. The male-side metal shell 123 mates with the male-side insulating base 122, forming the male-side mating body 120.

The male-side mating body 120 comprises a male-side joining space 1201 and a male-side locking side wall 1202. Notably, the male-side terminal joining structure 1211 is located within the male-side joining space 1201. The male-side locking side wall 1202 comprises a first male-side locking surface 12021, a second male-side locking surface 12022, a third male-side locking surface 12023, a first male-side locking direction D21, a second male-side locking direction D22, and a third male-side locking direction D23. The first male-side locking surface 12021 can extend along the first male-side locking surface extension line L121, the second male-side locking surface 12022 can extend along the second male-side locking surface extension line L122, and the third male-side locking surface 12023 can extend along the third male-side locking surface extension line L123. The first male-side locking direction D21 can extend along the first male-side locking direction extension line L221, the second male-side locking direction D22 can extend along the second male-side locking direction extension line L222, and the third male-side locking direction D23 can extend along the third male-side locking direction extension line L223.

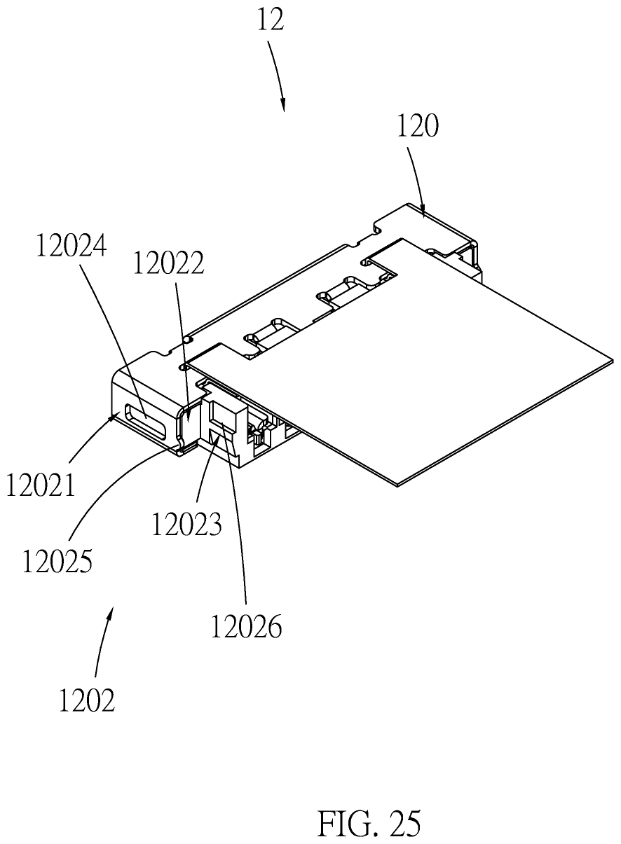

As shown in FIGS. 25 to 30, the first male-side locking surface 12021, the second male-side locking surface 12022, and the third male-side locking surface 12023 are located on the male-side metal shell 123. However, this configuration is not limiting; the second male-side locking surface 12022 may alternatively be located on the male-side insulating base 122, and the third male-side locking surface 12023 may also be located on the male-side insulating base 122.

In these embodiments, the first male-side locking surface extension line L121 and the second male-side locking surface extension line L122 can extend to intersect substantially, and the third male-side locking surface extension line L123 and the second male-side locking surface extension line L122 can extend to intersect substantially. Similarly, the first male-side locking direction extension line L221 and the second male-side locking direction extension line L222 can extend to intersect substantially, and the third male-side locking direction extension line L223 and the second male-side locking direction extension line L222 can extend to intersect substantially.

Additionally, the male-side locking side wall 1202 also comprises a first male-side locking structure 12024, a second male-side locking structure 12025, and a third male-side locking structure 12026. The first male-side locking structure 12024 is installed on the first male-side locking surface 12021, the second male-side locking structure 12025 is installed on the second male-side locking surface 12022, and the third male-side locking structure 12026 is installed on the third male-side locking surface 12023.

It should be noted that in the above embodiment, the first male-side locking structure 12024, the second male-side locking structure 12025, and the third male-side locking structure 12026 are either recessed structures or protruding structures. This allows the size of the male-side connector 12 to be reduced, further enabling electronic devices using the male-side connector 12 to continue evolving towards a more compact design.

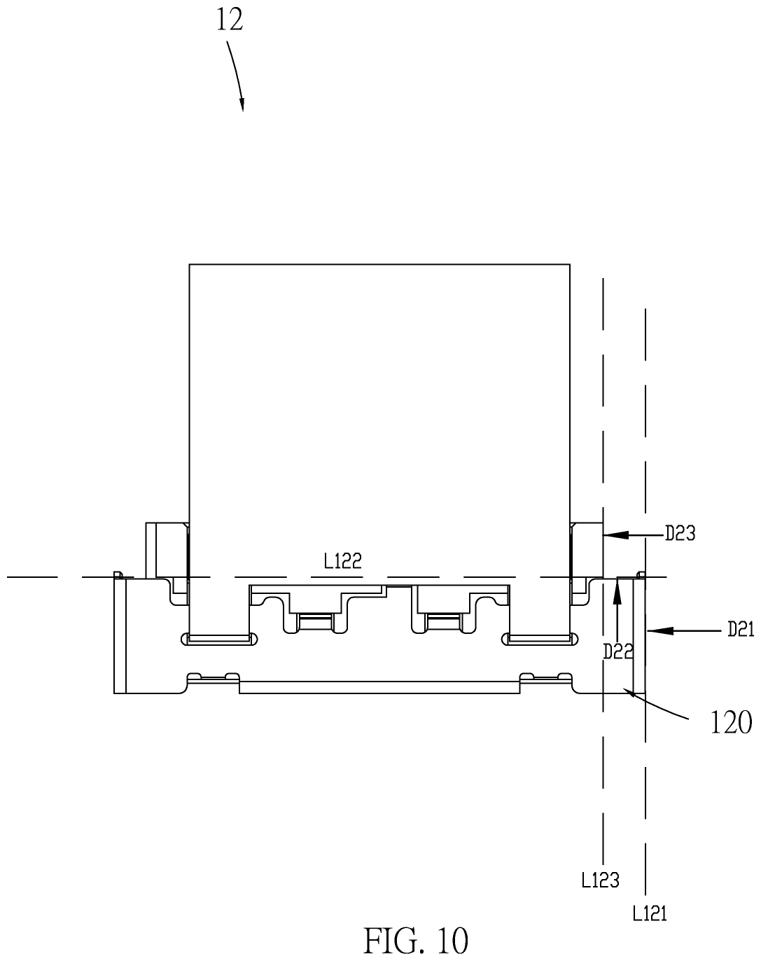

As shown in FIGS. 10 to 11 and FIGS. 29 to 30, the first male-side locking surface extension line L121 and the second male-side locking surface extension line L122 intersect perpendicularly, and the third male-side locking surface extension line L123 also intersects perpendicularly with the second male-side locking surface extension line L122. The first male-side locking direction extension line L221 intersects perpendicularly with the second male-side locking direction extension line L222, while the third female-side locking direction extension line L213 intersects perpendicularly with the second female-side locking direction extension line L212. However, not limited to the aforementioned content; the first male-side locking surface extension line L121 and the second male-side locking surface extension line L122 may also optionally not intersect substantially perpendicularly. The third male-side locking surface extension line L123 and the second male-side locking surface extension line L122 may also optionally not intersect substantially perpendicularly. The first male-side locking direction extension line L221 and the second male-side locking direction extension line L222 may also optionally not intersect substantially perpendicularly. The third female-side locking direction extension line L213 and the second female-side locking direction extension line L212 may also optionally not intersect substantially perpendicularly.

It should be noted that in the above embodiment, the female-side locking side wall 1102 can abut the male-side locking side wall 1202, guiding the male-side connector 12 into the female-side joining space 1101. This allows the female-side terminal joining structure 1111 of the female-side connector 11 to be joined with the male-side terminal joining structure 1211 of the male-side connector 12. Furthermore, as the male-side connector 12 enters the female-side joining space 1101, the first female-side locking structure 11024 of the female-side connector 11 can lock the first male-side locking structure 12024 of the male-side connector 12 in the first female-side locking direction D11, the second female-side locking structure 11025 of the female-side connector 11 can lock the second male-side locking structure 12025 of the male-side connector 12 in the second female-side locking direction D12, and the third female-side locking structure 11026 of the female-side connector 11 can lock the third male-side locking structure 12026 of the male-side connector 12 in the third female-side locking direction D13. This prevents the male-side connector 12 from detaching from the joined female-side connector 11, thereby addressing the issue of the male-side connector 12 easily detaching from the joined female-side connector 11. This design maintains the joining relationship between the female-side terminal joining structure 1111 and the male-side terminal joining structure 1211, ensuring that the signal transmission function between the female-side connector 11 and the male-side connector 12 meets expectations and allowing the assembly to be widely used in various electronic devices.

Accordingly, in the above embodiment, the male-side locking side wall 1202 can abut the female-side locking side wall 1102, guiding the female-side connector 11 into the male-side joining space 1201, allowing the male-side terminal joining structure 1211 of the male-side connector 12 to mate with the female-side terminal joining structure 1111 of the female-side connector 11. Additionally, as the female-side connector 11 enters the male-side joining space 1201, the first male-side locking structure 12024 of the male-side connector 12 can lock the first female-side locking structure 11024 of the female-side connector 11 in the first male-side locking direction D21, the second male-side locking structure 12025 of the male-side connector 12 can lock the second female-side locking structure 11025 of the female-side connector 11 in the second male-side locking direction D22, and the third male-side locking structure 12026 of the male-side connector 12 can lock the third female-side locking structure 11026 of the female-side connector 11 in the third male-side locking direction D23. This prevents the female-side connector 11 from detaching from the joined male-side connector 12, addressing the issue of the female-side connector 11 easily detaching from the joined male-side connector 12. This design maintains the mating relationship between the male-side terminal joining structure 1211 and the female-side terminal joining structure 1111, ensuring that the signal transmission function between the male-side connector 12 and the female-side connector 11 meets expectations, allowing the assembly to be widely used in various electronic devices.

It should be noted that the connector assembly with its female-side and male-side connectors in this application can omit some components and are not limited to the embodiments mentioned above.

For example, the female-side connector in this application may only comprise: a female-side conductive terminal, a female-side insulating base, and a female-side metal shell. The female-side conductive terminal comprises a female-side terminal joining structure. The female-side insulating base is embedded with the female-side conductive terminal. The female-side metal shell is mated with the female-side insulating base to form a female-side mating body, which comprises a female-side joining space and a female-side locking side wall. The female-side terminal joining structure is located within the female-side joining space, and the female-side locking side wall comprises a first female-side locking direction and a second female-side locking direction, and the first female-side locking direction can extend along the first female-side locking direction extension line, and the second female-side locking direction can extend along the second female-side locking direction extension line. The first female-side locking direction extension line and the second female-side locking direction extension line may extend and substantially intersect. The female-side locking side wall also comprises a first female-side locking structure and a second female-side locking structure, and the female-side locking side wall can guide the male-side connector into the female-side joining space to be joined with the female-side terminal joining structure. Additionally, when the male-side connector enters the female-side joining space, the first female-side locking structure can lock with the male-side connector along the first female-side locking direction, and the second female-side locking structure can lock with the male-side connector along the second female-side locking direction, maintaining the mating relationship between the female-side terminal joining structure and the male-side connector.

Furthermore, the male-side connector in this application may only comprise: a male-side conductive terminal, a male-side insulating base, and a male-side metal shell. The male-side conductive terminal comprises a male-side terminal joining structure. The male-side insulating base is embedded with the male-side conductive terminal. The male-side metal shell is mated with the male-side insulating base to form a male-side mating body, and the male-side mating body comprises a male-side joining space and a male-side locking side wall. The male-side terminal joining structure is located within the male-side joining space, and the male-side locking side wall comprises a first male-side locking direction and a second male-side locking direction, and the first male-side locking direction can extend along the first male-side locking direction extension line, and the second male-side locking direction can extend along the second male-side locking direction extension line. The first male-side locking direction extension line and the second male-side locking direction extension line may extend and substantially intersect. The male-side locking side wall also comprises a first male-side locking structure and a second male-side locking structure, and the male-side locking side wall can guide the female-side connector into the male-side joining space to mate with the male-side terminal joining structure. Additionally, when the female-side connector enters the male-side joining space, the first male-side locking structure can lock with the female-side connector along the first male-side locking direction, and the second male-side locking structure can lock with the female-side connector along the second male-side locking direction, maintaining the mating relationship between the male-side terminal joining structure and the female-side connector.

Moreover, the connector assembly in this application may only comprise: a female-side connector and a male-side connector. The female-side locking side wall can abut the male-side locking side wall, guiding the female-side terminal joining structure to be joined with the male-side terminal joining structure. The first female-side locking structure can lock with the first male-side locking structure, and the second female-side locking structure can lock with the second male-side locking structure, maintaining the mating relationship between the male-side terminal joining structure and the female-side terminal joining structure.

In summary, this application provides a connector assembly and its female-side connector and male-side connector. The provided female-side and male-side connectors are equipped with a metal shell and an insulating base, wherein the metal shell can be mated with the insulating base to form a locking side wall, which allows the male-side connector to lock with the female-side connector, preventing the male-side connector from detaching from the joined female-side connector. This resolves the technical issue of the male-side connector easily detaching from the joined female-side connector, ensuring that the signal transmission function between the female-side connector and the male-side connector meets expectations, thus enabling the connector assembly to be widely applied in various electronic devices. It should be noted that “male-side” can also be referred to as “male-end,” and “female-side” can also be referred to as “female-end.”

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A female-side connector, which enables to join with a male-side connector, and the female-side connector comprises:
a female-side conductive terminal, comprising a female-side terminal joining structure;
a female-side insulating base, being embedded with the female-side conductive terminal; and
a female-side metal shell, being mated with the female-side insulating base, enables the female-side metal shell and the female-side insulating base to form a female-side mating body, and the female-side mating body comprises a female-side joining space and a female-side locking side wall, wherein the female-side terminal joining structure is located within the female-side joining space, and the female-side locking side wall comprises a first female-side locking direction and a second female-side locking direction, and the first female-side locking direction extends along a first female-side locking direction extension line, and the second female-side locking direction extends along a second female-side locking direction extension line, and the first female-side locking direction extension line and the second female-side locking direction extension line can extend and intersect substantially, and the female-side locking side wall also comprises a first female-side locking structure and a second female-side locking structure, wherein
the female-side locking side wall guides the male-side connector into the female-side joining space to join with the female-side terminal joining structure; and
when the male-side connector enters the female-side joining space, the first female-side locking structure locks the male-side connector in the first female-side locking direction, and the second female-side locking structure locks the male-side connector in the second female-side locking direction, to maintain the joining relationship between the female-side terminal joining structure and the male-side connector.

2. The female-side connector of claim 1, wherein the first female-side locking direction extension line and the second female-side locking direction extension line intersect substantially perpendicularly.

3. The female-side connector of claim 1, wherein the first female-side locking structure and the second female-side locking structure are positioned on the female-side metal shell.

4. The female-side connector of claim 1, wherein the first female-side locking structure is positioned on the female-side metal shell, and the second female-side locking structure is positioned on the female-side insulating base.

5. The female-side connector of claim 1, wherein the female-side locking side wall also comprises a third female-side locking direction, and the third female-side locking direction extends along a third female-side locking direction extension line, and the third female-side locking direction extension line and the second female-side locking direction extension line can extend and intersect substantially with each other, and the female-side locking side wall further comprises a third female-side locking structure, wherein when the male-side connector enters the female-side joining space, the third female-side locking structure locks the male-side connector in the third female-side locking direction to maintain the joining relationship between the female-side terminal joining structure and the male-side connector.

6. The female-side connector of claim 5, wherein the third female-side locking direction extension line and the second female-side locking direction extension line intersect substantially perpendicularly.

7. The female-side connector of claim 5, wherein the third female-side locking structure is positioned on the female-side metal shell or the female-side insulating base.

8. The female-side connector of claim 5, wherein the first female-side locking structure, the second female-side locking structure, and the third female-side locking structure are either a recessed structure or a protruding structure.

9. The female-side connector of claim 5, wherein the female-side metal shell comprises a first female-side metal locking sub-shell, a second female-side metal locking sub-shell, and a third female-side metal locking sub-shell, in the female-side mating body, the first female-side metal locking sub-shell, the second female-side metal locking sub-shell, and the third female-side metal locking sub-shell are bent and mated with the female-side insulating base, respectively, wherein the first female-side locking structure is positioned on the first female-side metal locking sub-shell, the second female-side locking structure is positioned on the second female-side metal locking sub-shell, and the third female-side locking structure female-side locking structure is positioned on the third female-side metal locking sub-shell.

10. The female-side connector of claim 9, wherein the second female-side metal locking sub-shell connects with the third female-side metal locking sub-shell, enabling the second female-side metal locking sub-shell and the third female-side metal locking sub-shell to form a bent structure that can mate with the female-side insulating base.

11. A male-side connector, which enables to join with a female-side connector, and the male-side connector comprises:
a male-side conductive terminal, comprising a male-side terminal joining structure;
a male-side insulating base, being embedded with the male-side conductive terminal; and
a male-side metal shell, being mated with the male-side insulating base, enables the male-side metal shell and the male-side insulating base to form a male-side mating body, and the male-side mating body comprises a male-side joining space and a male-side locking side wall, wherein the male-side terminal joining structure is located within the male-side joining space, and the male-side locking side wall comprises a first male-side locking direction and a second male-side locking direction, and the first male-side locking direction extends along a first male-side locking direction extension line, and the second male-side locking direction extends along a second male-side locking direction extension line, and the first male-side locking direction extension line and the second male-side locking direction extension line can extend and intersect substantially, and the male-side locking side wall also comprises a first male-side locking structure and a second male-side locking structure, wherein
the male-side locking side wall guides the female-side connector into the male-side joining space to join with the male-side terminal joining structure; and
when the female-side connector enters the male-side joining space, the first male-side locking structure locks the female-side connector in the first male-side locking direction, and the second male-side locking structure locks the female-side connector in the second male-side locking direction, to maintain the joining relationship between the male-side terminal joining structure and the female-side connector.

12. The male-side connector of claim 11, wherein the first male-side locking direction extension line and the second male-side locking direction extension line intersect substantially perpendicularly.

13. The male-side connector of claim 11, wherein the first male-side locking structure and the second male-side locking structure are positioned on the male-side metal shell.

14. The male-side connector of claim 11, wherein the first male-side locking structure is positioned on the male-side metal shell, and the second male-side locking structure is positioned on the male-side insulating base.

15. The male-side connector of claim 11, wherein the male-side locking side wall also comprises a third male-side locking direction, and the third male-side locking direction extends along a third male-side locking direction extension line, and the third male-side locking direction extension line and the second male-side locking direction extension line can extend and intersect substantially with each other, and the male-side locking side wall further comprises a third male-side locking structure, wherein when the female-side connector enters the male-side joining space, the third male-side locking structure locks the female-side connector in the third male-side locking direction to maintain the joining relationship between the male-side terminal joining structure and the female-side connector.

16. The male-side connector of claim 15, wherein the second male-side locking direction extension line and the third male-side locking direction extension line intersect substantially perpendicularly.

17. The male-side connector of claim 15, wherein the third male-side locking structure is positioned on the male-side insulating base.

18. The male-side connector of claim 15, wherein the first male-side locking structure, the second male-side locking structure, and the third male-side locking structure are either a recessed structure or a protruding structure.

19. A connector assembly, comprising:
a female-side connector, comprising:
a female-side conductive terminal, comprising a female-side terminal joining structure;
a female-side insulating base, being embedded with the female-side conductive terminal; and
a female-side metal shell, being mated with the female-side insulating base, enables the female-side metal shell and the female-side insulating base to form a female-side mating body, and the female-side mating body comprises a female-side joining space and a female-side locking side wall, wherein the female-side terminal joining structure is located within the female-side joining space, and the female-side locking side wall comprises a first female-side locking direction and a second female-side locking direction, and the first female-side locking direction extends along a first female-side locking direction extension line, and the second female-side locking direction extends along a second female-side locking direction extension line, and the first female-side locking direction extension line and the second female-side locking direction extension line can extend and intersect substantially, and the female-side locking side wall also comprises a first female-side locking structure and a second female-side locking structure;
a male-side connector, which enables to join with a female-side connector, and the male-side connector comprises:
a male-side conductive terminal, comprising a male-side terminal joining structure;
a male-side insulating base, being embedded with the male-side conductive terminal; and
a male-side metal shell, being mated with the male-side insulating base, enables the male-side metal shell and the male-side insulating base to form a male-side mating body, and the male-side mating body comprises a male-side joining space and a male-side locking side wall, wherein the male-side terminal joining structure is located within the male-side joining space, and the male-side locking side wall comprises a first male-side locking direction and a second male-side locking direction, and the first male-side locking direction extends along a first male-side locking direction extension line, and the second male-side locking direction extends along a second male-side locking direction extension line, and the first male-side locking direction extension line and the second male-side locking direction extension line can extend and intersect substantially, and the male-side locking side wall also comprises a first male-side locking structure and a second male-side locking structure, wherein
the female-side locking side wall guides the male-side connector into the female-side joining space to join with the female-side terminal joining structure;
when the male-side connector enters the female-side joining space, the first female-side locking structure locks the male-side connector in the first female-side locking direction, and the second female-side locking structure locks the male-side connector in the second female-side locking direction, to maintain the joining relationship between the female-side terminal joining structure and the male-side connector;
the male-side locking side wall guides the female-side connector into the male-side joining space to join with the male-side terminal joining structure; and
when the female-side connector enters the male-side joining space, the first male-side locking structure locks the female-side connector in the first male-side locking direction, and the second male-side locking structure locks the female-side connector in the second male-side locking direction, to maintain the joining relationship between the male-side terminal joining structure and the female-side connector; wherein
the female-side locking side wall abuts the male-side locking side wall, guiding the female-side terminal joining structure to join with the male-side terminal joining structure; and
the first female-side locking structure locks the first male-side locking structure, and the second female-side locking structure locks the second male-side locking structure, to maintain the joining relationship between the male-side terminal joining structure and the female-side terminal joining structure.

20. The connector assembly of claim 19, wherein the first female-side locking structure and the second female-side locking structure are positioned on the female-side metal shell; and the first male-side locking structure and the second male-side locking structure are positioned on the male-side metal shell.

21. The connector assembly of claim 19, wherein the first female-side locking structure is positioned on the female-side metal shell; the second female-side locking structure is positioned on the female-side insulating base; the first male-side locking structure is positioned on the male-side metal shell; and the second male-side locking structure is positioned on the male-side insulating base.

22. The connector assembly of claim 19, wherein the first female-side locking structure and the male-side locking structure are correspondingly a recessed structure and a protruding structure, respectively; and the second female-side locking structure and the second male-side locking structure are correspondingly a recessed structure and a protruding structure, respectively.

23. A connector assembly, comprising:
a female-side connector, comprising:
a female-side conductive terminal, comprising a female-side terminal joining structure;
a female-side insulating base, being embedded with the female-side conductive terminal; and
a female-side metal shell, being mated with the female-side insulating base, enables the female-side metal shell and the female-side insulating base to form a female-side mating body, and the female-side mating body comprises a female-side joining space and a female-side locking side wall, wherein the female-side terminal joining structure is located within the female-side joining space, and the female-side locking side wall comprises a first female-side locking direction and a second female-side locking direction, and the first female-side locking direction extends along a first female-side locking direction extension line, and the second female-side locking direction extends along a second female-side locking direction extension line, and the first female-side locking direction extension line and the second female-side locking direction extension line can extend and intersect substantially, and the female-side locking side wall also comprises a first female-side locking structure and a second female-side locking structure;
a male-side connector, which enables to join with a female-side connector, and the male-side connector comprises:
a male-side conductive terminal, comprising a male-side terminal joining structure;
a male-side insulating base, being embedded with the male-side conductive terminal; and
a male-side metal shell, being mated with the male-side insulating base, enables the male-side metal shell and the male-side insulating base to form a male-side mating body, and the male-side mating body comprises a male-side joining space and a male-side locking side wall, wherein the male-side terminal joining structure is located within the male-side joining space, and the male-side locking side wall comprises a first male-side locking direction and a second male-side locking direction, and the first male-side locking direction extends along a first male-side locking direction extension line, and the second male-side locking direction extends along a second male-side locking direction extension line, and the first male-side locking direction extension line and the second male-side locking direction extension line can extend and intersect substantially, and the male-side locking side wall also comprises a first male-side locking structure and a second male-side locking structure, wherein,
the female-side locking side wall guides the male-side connector into the female-side joining space to join with the female-side terminal joining structure;
when the male-side connector enters the female-side joining space, the first female-side locking structure locks the male-side connector in the first female-side locking direction, and the second female-side locking structure locks the male-side connector in the second female-side locking direction, to maintain the joining relationship between the female-side terminal joining structure and the male-side connector;
the female-side locking side wall also comprises a third female-side locking direction, and the third female-side locking direction extends along a third female-side locking direction extension line, and the third female-side locking direction extension line and the second female-side locking direction extension line can extend and intersect substantially with each other, and the female-side locking side wall further comprises a third female-side locking structure, wherein when the male-side connector enters the female-side joining space, the third female-side locking structure locks the male-side connector in the third female-side locking direction to maintain the joining relationship between the female-side terminal joining structure and the male-side connector;
the male-side locking side wall guides the female-side connector into the male-side joining space to join with the male-side terminal joining structure; and
when the female-side connector enters the male-side joining space, the first male-side locking structure locks the female-side connector in the first male-side locking direction, and the second male-side locking structure locks the female-side connector in the second male-side locking direction, to maintain the joining relationship between the male-side terminal joining structure and the female-side connector; and
the male-side locking side wall also comprises a third male-side locking direction, and the third male-side locking direction extends along a third male-side locking direction extension line, and the third male-side locking direction extension line and the second male-side locking direction extension line can extend and intersect substantially with each other, and the male-side locking side wall further comprises a third male-side locking structure, wherein when the female-side connector enters the male-side joining space, the third male-side locking structure locks the female-side connector in the third male-side locking direction to maintain the joining relationship between the male-side terminal joining structure and the female-side connector; wherein
the female-side locking side wall abuts the male-side locking side wall, guiding the female-side terminal joining structure to join with the male-side terminal joining structure; and
the first female-side locking structure locks the first male-side locking structure, the second female-side locking structure locks the second male-side locking structure, and the third female-side locking structure locks the third male-side locking structure, to maintain the joining relationship between the male-side terminal joining structure and the female-side terminal joining structure.

24. The connector assembly of claim 23, wherein the first female-side locking structure and the second female-side locking structure are positioned on the female-side metal shell; the first male-side locking structure and the second male-side locking structure are positioned on the male-side metal shell; the third female-side locking structure is positioned on either the female-side metal shell or the female-side insulating base; and
the third male-side locking structure is positioned on the male-side insulating base.

25. The connector assembly of claim 23, wherein the first female-side locking structure is positioned on the female-side metal shell; the second female-side locking structure is positioned on the female-side insulating base; the first male-side locking structure is positioned on the male-side metal shell; the second male-side locking structure is positioned on the male-side insulating base; the third female-side locking structure is positioned on either the female-side metal shell or the female-side insulating base; and the third male-side locking structure is positioned on the male-side insulating base.

26. The connector assembly according to claim 23, wherein the first female-side locking structure and the first male-side locking structure are respectively a recessed structure and a protruding structure with structurally corresponding configurations; the second female-side locking structure and the second male-side locking structure are respectively a recessed structure and a protruding structure with structurally corresponding configurations; and the third female-side locking structure and the third male-side locking structure are respectively a recessed structure and a protruding structure with structurally corresponding configurations.
